(19) United States
(12) Patent Application Publication
(10) Pub. No.: US 2011/0053286 A1
(43) Pub. Date: Mar. 3, 2011

(54) METHOD AND APPARATUS FOR MOVING STAGE DETECTION OF SINGLE MOLECULAR EVENTS

(75) Inventors: Nasanshargal Battulga, Ulaanbaatar (MN); Mitsu Reddy, Pearland, TX (US); Susan H. Hardin, College Station, TX (US)

(73) Assignee: LIFE TECHNOLOGIES CORPORATION, Carlsbad, CA (US)

(21) Appl. No.: 12/901,344

(22) Filed: Oct. 8, 2010

Related U.S. Application Data
(62) Division of application No. 11/781,166, filed on Jul. 20, 2007, now abandoned.
(60) Provisional application No. 60/832,098, filed on Jul. 20, 2006.

(51) Int. Cl. G01N 21/00

(52) U.S. Cl. 436/164

(57) ABSTRACT

An apparatus and method based on the apparatus is disclosed for detecting and monitoring chemical and/or bio-chemical reactions or interactions at the single molecule level, where detection and monitoring is improved by moving the viewing field of the detector in a controlled manner. The motion of the moving frame is accomplished either through software in the detector system or is accomplished by moving the reacting system. The motion is controlled and is either linear, circular or elliptical. The motion provides for improved site identification or mapping, improved event detection and monitoring, improved signal recognition and improved noise reduction.

### RELATED APPLICATIONS

This application claims provisional priority to U.S. Provisional Patent Application No. 60/832,098 filed Jul. 20, 2006 (20 Jul. 2006).

### BACKGROUND OF THE INVENTION

1. Field of the Invention

The present invention relates to moving frame or stage single molecule detection apparatus such as a single molecule sequencing apparatus and method for using the apparatus.

More particularly, the present invention relates to a moving frame or stage single molecule, complex or assembly detection apparatus such as a moving stage or frame sequencing apparatus and method for using the apparatus. The apparatus includes a medium including a confinement or immobilization zone and a component delivery assembly adapted to delivery one reagent or a plurality of reagents to the zone, where the reagent or reagents confine or immobilize pre-reactive molecules, molecular complexes or molecular assemblages, where the molecule or molecules, a component of the molecular complex or complexes, a component of the molecular assembly or assemblages and/or the zone include a detectable agent such as a molecules, groups, tags, labels, agents or moieties having a detectable property. The apparatus also includes a detector adapted to detect reactive single molecule, complex or assembly sites inside the zone. The apparatus also include a means for moving a viewing window of the detector within the zone in a controlled manner (speed, direction, acceleration, etc.) or moving the zone relative to a fixed detector viewing window. The apparatus also includes an analyzer adapted to receive signals from the detector and to convert the signals into output data corresponding to the detected events occurring inside the zones associated with one, some or all of the reactive single molecule, complex or assembly sites.

2. Description of the Related Art

At present, nucleotide sequencing, oligonucleotide synthesis, peptide analysis, peptide synthesis, polysaccharide analysis, polysaccharide synthesis, mixed biomolecule analysis and synthesis and atomic or molecular reactions are preformed at the multi-molecule level using large or macroscope ensembles—generally synthetic chemical approaches.

Recently, however, there has been considerable emphasis placed on detection of chemical reactions occurring a small ensembles of molecular reaction sites and/or single molecular reaction sites, single molecule analysis, and single molecule synthesis. As the detection protocols and procedures for single molecule detection and the data analysis become more robust, new technologies will need to be developed to efficiently and effectively exploit this fast growing world of small molecule ensemble or single molecule detection systems.

Thus, there is a need in the art for an apparatus that is tailored to small molecule ensembles detection or single molecule detection and to improve detection and signal-to-noise.

### SUMMARY OF THE INVENTION

The present invention provides an apparatus for analyzing small, medium or large ensembles of atomic or molecular reaction sites or a single atomic or molecular reaction site. The apparatus includes a medium having a zone, where the zone is adapted to confine or immobilize a pre-reactive site or a plurality of pre-reactive sites. The apparatus also includes a component delivery assembly adapted to deliver one reagent or a plurality of reagents into or onto the zone to convert the pre-reactive sites into reactive sites, where one or more of the reagents, one or more of the components of the sites or components in or associated with the zone include at least one detectable group. The apparatus also includes a detection system capable of detecting the detectable group or detectable groups before, during and/or after one or a plurality of molecular reactions and/or interactions within a viewing field corresponding to the zone or to a small volume or portion of the zone. The apparatus also includes a means for moving the viewing field or the zone in a controlled trajectory or manner, while detecting the molecular reactions and/or interactions, sometimes referred to as detected events. This controlled motion of the viewing field or the zone is adapted to improve detection, to improve signal recognition, to improve signal-to-noise ratio and to improve noise reduction associated with the detected events. The apparatus also includes an analyzer capable of converting events detected by the detector into data relating to the detected events. Each reactive site or a component of the zone in close proximity to the site includes an agent having a detectable property that produces a detectable signal evidencing one reaction and/or interaction or a series of atomic or molecular reactions and/or interactions. The zones can be cavities, channels or other confinement volumes in which the pre-reactive sites can be confined and in many embodiments isolated, or the zones include binding agents complexed to, non-covalently bonded to or covalently bonded to a surface of the zone or complexed to, non-covalently bonded to or covalently bonded to a matrix disposed in the zone. The apparatus can be used to monitor nucleic acid synthesis by polymerases, amino acid synthesis by ribosomes, carbohydrate synthesis by carbohydrate synthetases, catalyst reactions, reactions inside cells, or any other reaction amenable to single molecule detection.

The present invention provides an apparatus for analyzing small, medium or large ensembles of atomic or molecular reaction sites or a single atomic or molecular reaction site. The apparatus includes a medium having a zone. The apparatus also includes a component delivery assembly adapted to deliver one or a plurality of reagents into or onto the zone to form pre-reactive sites within the zone. The apparatus also includes an initiator delivery assembly adapted to deliver one initiator or a plurality of initiator adapted to convert some or all of the pre-reactive sites into reactive sites. Each reactive site or a component of the zone in close proximity to the site includes an agent having a detectable property that produces a detectable signal evidencing one reaction and/or interaction or a series of atomic or molecular reactions and/or interactions. The apparatus also includes a detection system capable of detecting the detectable property or changes in the detectable property of some or all of the agents within a view field of the detection system before, during and/or after one or a plurality of molecular reactions and/or interactions at some or all of the reactive sites within the viewing field. The view field can be the entire zone or a small portion of the zone. The apparatus also includes a means for moving the field or the zone in a controlled trajectory or manner while detecting the molecular reactions or interactions, sometimes referred to as detected events. This controlled motion of the viewing field or zone is adapted to improve detection and signal-to-noise ratio of the reactive sites. The apparatus also includes an analyzer capable of converting events detected by the detector into data relating to the detected events.

The present invention also provides a sequencing apparatus for analyzing small, medium or large ensembles of active sequencing sites or a single active sequencing site. The apparatus includes a medium having a zone. The apparatus also includes a component delivery system adapted to deliver a primer, a nucleic acid or template, a polymerizing agent and monomers for the polymerizing agent into or onto the zone to form at least one active sequencing site. Alternatively, the apparatus can include a two stage or multi-stage component delivery system adapted to introduce in one step, two or three steps a primer, a template and a polymerizing agent into or onto the zone to form pre-sequencing complexes comprising a duplexed primer/template complex and a polymerizing agent. The apparatus also includes a monomer delivery system adapted to delivery monomers for the polymerizing agent, dNTPs, to convert the pre-sequencing sites into active sequencing sites within the zone. Each active site or a component of the zone in close proximity to the site includes an agent having a detectable property that produces a detectable signal evidencing one reaction and/or interaction or a series of atomic or molecular reactions and/or interactions. The apparatus includes a detection system capable of detecting the detectable property that undergoes changes before, during and/or after one monomer event or a plurality of monomer events, where the detection system includes a view field. The apparatus also includes a means for moving the field or zone in a controlled trajectory or manner, while detecting the events, sometimes referred to as detected events. This controlled motion of the viewing field or zone is adapted to improve detection and signal-to-noise ratio of the active sites. The apparatus also includes an analyzer capable of converting events detected by the detector into data relating to the detected events. The events can be incorporation events, binding events, non-binding events (collision events), or other monomer/site reactions and/or interactions.

### Substrate

The media for use in the apparatuses of the invention include a substrate having sparsely distributed binding sites formed thereon or therein, a substrate having a layer formed or disposed thereon having sparsely distributed binding sites, a substrate having a plurality of layers formed or disposed thereon having sparsely distributed binding sites or a substrate having a matrix formed or disposed thereon having sparsely distributed binding sites. In certain embodiment, the substrate is a thin glass substrate such as a cover slip and the sparsely distributed binding sites on formed on top of the glass surface.

### Methods

First General Method

The present invention also provides a method for analyzing small ensembles of atomic or molecular reaction sites or single atomic or molecular reaction site in a continuous reaction mode, an intermittent reaction mode, a periodic reaction mode, semi-periodic reaction mode, or mixed mode (a mixture of one or more of the other modes in any combination or permutation). The method includes to steps of providing a substrate including a zone, where the zone includes one site or a plurality of sparely distributed sites, where the sites can be an atomic site (a site in which an atom or collection of atoms for an active center such as a catalyst site), molecule, molecular complex or molecular assemblage. The sites can be simply confined in the zone, formed in the zone (forming catalytic sites or atomic assemblages in or on the zone), or immobilized to binding agents sparsely distributed on or in the zone. Each site, binding site, a donor structure/binding site, and/or a component of the zone proximate each site includes at least one agent having a detectable property, where multiple agents can be the same or different and in the case of multiple agents, the agents can be interactive or non-interactive.

Next, the method includes the step of detecting, with a detection system, detectable events occurring at some or all of the sites within a viewing field or field of view over a desired period of time, where the viewing field can be the entire zone or, and generally, a portion of the zone.

During detection of the detectable events, a viewing field or field of view of the detector or the zone is moved in a controlled manner or along a controlled trajectory. This motion can be accomplished by the detector if the detector is designed to move the viewing field, by moving the detector, or by moving the zone in a controlled trajectory. The controls for moving the viewing field or zone includes direction, linear velocity, angular velocity, linear acceleration, angular acceleration, and/or a combination of these components of motion. The trajectories can be linear, circular, elliptical, hyperbolic, rectangular, triangular, back-and-forth, side-to-side, or any other motion that permits the sites to move in a controlled manner within the viewing field. This motion permits improved location of active sites (detectable atomic site, molecules, complexes or assemblages) within the zone, improved signal recognition, improved noise identification and reduction, and/or improved signal-to-noise ratio.

Second General Method

The present invention also provides another method for analyzing small ensembles of atomic or molecular reaction sites or single atomic or molecular reaction site in a continuous reaction mode, an intermittent reaction mode, a periodic reaction mode, semi-periodic reaction mode, or mixed mode (a mixture of one or more of the other modes in any combination or permutation). The method includes to steps of providing a substrate including a zone, where the zone includes one pre-active site or a plurality of sparely distributed pre-active sites, where the sites can be an atomic site (a site in which an atom or collection of atoms for an active center such as a catalyst site), molecule, molecular complex or molecular assemblage. The sites can be simply confined in the zone, formed in the zone (forming catalytic sites or atomic assemblages in or on the zone), or immobilized to binding agents sparsely distributed on or in the zone. Each site, binding site and/or a component of the zone proximate each site includes at least one agent having a detectable property, where multiple agents can be the same or different and in the case of multiple agents, the agents can be interactive or non-interactive.

Next, the sites are detected and mapped to determine locations of active sites within a fielding field of a detector system. After mapping, some or all of the mapped pre-active sites are activated to form active sites capable of undergoing one, many, a series or a sequence of detectable reactions and/or interactions sometimes referred to herein as detectable events. The method next includes the step of detecting, with a detection system, detectable events occurring at some or all of the sites within a viewing field or field of view over a desired period of time, where the viewing field can be the entire zone or, and generally, a portion of the zone.

During detection of the detectable events, a viewing field or field of view of the detector or the zone is moved in a controlled manner or along a controlled trajectory. This motion can be accomplished by the detector if the detector is designed to move the viewing field, by moving the detector, or by moving the zone in a controlled trajectory. The controls for moving the viewing field or zone includes direction, linear velocity, angular velocity, linear acceleration, angular acceleration, and/or a combination of these components of motion. The trajectories can be linear, circular, elliptical, hyperbolic, rectangular, triangular, back-and-forth, side-to-side, or any other motion that permits the sites to move in a controlled manner within the viewing field. This motion permits improved location of active sites (detectable atomic site, molecules, complexes or assemblages) within the zone, improved signal recognition, improved noise identification and reduction, and/or improved signal-to-noise ratio.

In both of these general methods, the sites can be formed in or on the zone in multistep processes. For example, the zone can be provided with sparsely distributed binding sites. To some or all of these binding sites, a component of the pre-active sites can be immobilized. Then, the remainder of the components to complete the assembly of a pre-active site can be added, either all at once or in a step-wise fashion. After formation of the pre-active sites, initiators designed to convert some or all of the pre-active into active sites can be added. The exact pre-active site assembly process is generally dependent on the system to be monitored and it a matter of personal preferences.

### DEFINITIONS USED IN THE INVENTION

The term “distinct and detectable active site” means an atomic site or structure, a molecule, a molecular complex, or a molecular assemblage capable of undergoing one, many, a series or a sequence of biochemical, chemical and/or physical reactions and/or interactions, and capable of being detected before, during and/or after such reactions and/or interactions. In certain embodiments, molecular complexes and molecular assemblages includes those capable of forming nucleic acid sequences, peptide sequences, saccharide sequences, mixed sequences (nucleic acid-peptide sequences, peptide-saccharide sequences, nucleic acid-saccharide sequences, etc.) or other step-by-step polymerization reaction. In other embodiments, the assemblages are atomic sites comprising active catalytic sites.

The term “distinct and detectable single active site” means an individual atomic site or structure, a molecule, a molecular complex, or a molecular assemblage capable of undergoing one, many, a series or a sequence of biochemical, chemical and/or physical reactions and/or interactions, or to undergo a cyclical biochemical, chemical or physical reaction and/or interaction, and capable of being individually detected before, during and/or after a reaction and/or interaction without interference from other single active site. Such single molecular assemblages are well separated from other molecular assemblages permitting detection and analysis of signals of events (the cyclic reaction) occurring uniquely at that molecular assembly. In certain embodiments, molecular assemblages includes molecular assemblages capable of forming nucleic acid sequences, peptide sequences, saccharide sequences, mixed sequences (nucleic acid-peptide sequences, peptide-saccharide sequences, nucleic acid-saccharide sequences, etc.) or other step-by-step polymerization reaction.

The “bonded to” means that chemical and/or physical interactions sufficient to maintain the polymerase within a given region of the substrate under normal polymerizing conditions. The chemical and/or physical interactions include, without limitation, covalent bonding, ionic bonding, hydrogen bonding, apolar bonding, attractive electrostatic interactions, dipole interactions, or any other electrical or quantum mechanical interaction sufficient in toto to maintain the polymerase in its desired region.

The term “monomer” as used herein means any compound that can be incorporated into a growing molecular chain by a given polymerase. Such monomers include, without limitations, naturally occurring nucleotides (e.g., ATP, GTP, TTP, UTP, CTP, dATP, dGTP, dTTP, dUTP, dCTP, synthetic analogs), precursors for each nucleotide, non-naturally occurring nucleotides and their precursors or any other molecule that can be incorporated into a growing polymer chain by a given polymerase. Additionally, amino acids (natural or synthetic) for protein or protein analog synthesis, mono saccharides for carbohydrate synthesis or other monomeric syntheses.

The term “polymerizing agents” means any agent capable of polymerizing monomers in a step-wise fashion or in a step-wise fashion relative to a specific template such as a DNA or RNA polymerase, reverse transcriptase, or the like, ribosomes, carbohydrate synthesizing enzymes or enzyme system, or other enzymes systems that polymerize monomers in a step-wise fashion.

The term “polymerase” as used herein means any molecule or molecular assembly that can polymerize a set of monomers into a polymer having a predetermined sequence of the monomers, including, without limitation, naturally occurring polymerases or reverse transcriptases, mutated naturally occurring polymerases or reverse transcriptases, where the mutation involves the replacement of one or more or many amino acids with other amino acids, the insertion or deletion of one or more or many amino acids from the polymerases or reverse transcriptases, or the conjugation of parts of one or more polymerases or reverse transcriptases, non-naturally occurring polymerases or reverse transcriptases. The term polymerase also embraces synthetic molecules or molecular assembly that can polymerize a polymer having a pre-determined sequence of monomers, or any other molecule or molecular assembly that may have additional sequences that facilitate purification and/or immobilization and/or molecular interaction of the tags, and that can polymerize a polymer having a pre-determined or specified or templated sequence of monomers.

The term “atomic system or structure” means a system or structure including an active atomic site such as an active catalytic site.

The term “molecule” means a single molecular species.

The term “molecular complex” means a molecular structure comprising at least two molecules, which are associated with, non-covalently bonded to or covalently bonded to one another.

The term “molecular assemblage” means a molecular structure comprising three or more molecules, which are associated with or non-covalently bonded.

The term “reaction and/or interaction” means any chemical event that results in the formation or destruction of one or more chemical bonds or a physical event that results in a change in one or more properties of a molecule, molecular complex or molecular assembly. The term reaction includes actual chemical reaction, binding interactions that result in a temporary associated complex, transient complexes, proximal association or any other type of chemical and/or physical interaction that give rise to a change in a detectable property of the interacting or reacting molecular, atomic, ionic, molecular complexes (comprising neutral and/or charged molecules), and/or molecular assemblages (comprising neutral and/or charged molecules).

The term “variant” means any genetically modified enzyme, where the mutation is designed to augment the reactivity, activity, processivity, binding efficiency, release efficiency, or any other aspect of an enzymes chemical behavior.

### BRIEF DESCRIPTION OF THE DRAWINGS

The invention can be better understood with reference to the following detailed description together with the appended illustrative drawings in which like elements are numbered the same.

FIG. 1A depicts a block diagram of an embodiment of a moving frame apparatus of this invention.

FIG. 1B depicts a block diagram of another embodiment of a moving frame apparatus of this invention.

FIG. 1C depicts a block diagram of another embodiment of a moving frame apparatus of this invention.

FIG. 2A depicts a block diagram of an embodiment of a moving frame apparatus of this invention.

FIG. 2B depicts a block diagram of another embodiment of a moving frame apparatus of this invention.

FIG. 2C depicts a block diagram of another embodiment of a moving frame apparatus of this invention.

FIG. 3A-J depict camera images and anti-correlated donor-acceptor events as the viewing field is moved in a controlled linear manner.

FIG. 4A-I depict embodiments of substrates for use in the apparatuses of FIGS. 1A-C and FIG. 2A-C.

FIG. 5C depicts an expanded view of a viewing field of FIGS. 1A-C.

FIG. 5D depicts an expanded view of a viewing field of FIG. 2A-C.

### DETAILED DESCRIPTION OF THE INVENTION

The inventors have found that an apparatus can be constructed for automated binding, initiating, reacting and detecting reactions at one or a plurality of single molecular sites (sites comprising one molecule or a molecular assemblage, complex or other collection of molecules and/or atoms). In certain embodiments, the automated apparatus is designed to bind, initiate, synthesize and sequence naturally occurring or man-made macromolecules including biomacromolecules such as oligonucleotides, polynucleotides, genes, chromosomes, or similar nucleic acid materials, polypeptides, proteins, enzymes, or similar amino acid containing materials, oligosaccharides, polysaccharides, starches or other sugar containing materials or biomolecules containing a mixture of nucleotides, amino acids, saccharides (sugars) such as ribozymes, RNA/DNA mixed nucleic acids, modified proteins (glycated, phosphorylated, etc.) and synthetic or man-made analogs thereof. The inventors have also found that apparatus can be used to automate sequencing, synthesis and analysis of the above-listed biomolecules or can be used as a computer memory—storing and retrieving information at the molecular level, or can be used to detect and monitor reactions as the single molecule level.

The apparatus includes a substrate including a zone adapted to confine or immobilize a pre-reactive atomic system, molecule, molecular complex or molecular assemblage or a plurality of molecules, molecular complexes or molecular assemblages therein. The apparatus can also include a component delivery assembly adapted to deliver one component or a plurality of components to the zone to form pre-reactive atomic systems, molecules, molecular complexes or molecular assemblages confined or immobilized in the zone. Each atomic system, molecule, molecular complex, molecular assemblage or a zone site proximate each atomic system, molecule, complex, or assemblage includes at least one detectable agent such as a tag or label, having a detectable property. In certain embodiments, the pre-reactive sites are sparsely distributed to form a plurality of single atomic system, molecule, complex, or assemblage sites. The apparatus also includes a detector adapted to detect reactive single sites within a viewing field comprising the zone or a portion thereof. The apparatus also includes a means for moving the viewing field of the detector or moving the zone relative to a fixed detector in a controlled manner (speed, direction, acceleration, etc.). The apparatus also includes an analyzer adapted to receive signals from the detector and to convert the signals into output data corresponding to the detected events occurring inside the viewing field associated with one, some or all of the reactive and detected sites. Immobilization can be affected through any one of the components, primer, template, polymerizing agent or donor. In the case of an immobilized donor, the donor, such as a nanocrystal, quantum dot or other light emitting nanostructure, is immobilized on or in the zone via a binding agent and then one of the other components, primer, template or polymerizing agent (in most embodiments the polymerizing agent) is immobilized to the donor by a binding agent, where the two binding agents can be the same or different. In another embodiment, the system alternatively detects four (4) colors that correspond to the four bases, A, C, G, and T, where the bases are identified in a non interactive format either by direct detection of a released fluorophore or subsequence transformation of a pre-photoactive group into a photoactive group after released during incorporations.

The apparatus can use a continuous substrate including zones adapted to have active sites immobilized on the surface of the zones or in a matrix formed on the zones, where the active sites can be atomic or molecular. The immobilization is generally accomplished by immobilizing a component of the site to the surface or to the matrix a binding sites formed on the surface or in the matrix and then added the remaining components to form the active sites. Alternatively, the active sites can be constructed on or in the zone by know chemical deposition processes such as vapor deposition, ion beam implantation or the like. In the case of sequencing of nucleic acids, the pre-reactive sites comprise primer/template/polymerase complexes, and the complexes can be immobilized through any one of the components, primer, template or polymerizing agent. The apparatus is adapted to move the continuous substrate so that each zone passes through a plurality of stations. Some of the stations are component, activator, or initiator introduction stations and others are detector stations. As the continuous substrate passes through the component introduction stations, one or more components are introduced into or onto the zone until pre-reactive sites are formed in or on the zone, generally the pre-reactive sites are sparely distributed in or on the zone. Each atomic system, molecule, molecular complex, molecular assemblage or a zone site proximate each atomic system, molecule, complex, or assemblage includes at least one detectable agent such as a tag or label, having a detectable property. In certain embodiments, the pre-reactive sites are sparsely distributed to form a plurality of single atomic system, molecule, complex, or assemblage sites. Once all the necessary components have been introduced into or onto the zones to form pre-reactive sites, then substrate is moved so that the zone passes through a mapping station, where active, pre-reactive sites within a viewing field are mapped by detecting the detectable property of the agent or agents associated with each pre-reactive site—their locations are determined relative to a detection grid used for alignment and calibration or registration of the mapped active species. After mapping, a final component or final components are added to the zone by passing the zone through a reaction initiation station, where some or all of the pre-reactive sites are converted to reactive sites. After the activation, the zone passes through a second detection station, where detector data is collected evidencing reaction events that occur within a viewing field comprising the entire zone or a portion thereof during a given detection period. The apparatus also includes an analyzer adapted to receive the mapping data and the event data and register the viewing field of the mapping station to the viewing field of the detection station. In certain embodiments, the mapping station and the detecting station are the same station and the apparatus merely moves the zone in and out of the station. In most sequencing embodiments, the detector is capable of analyzing signals from each monomer type (each monomer type includes a unique fluorescent acceptor) and at least one additional signal, generally a fluorescent donor. For two color sequencing, the detectors of this invention would detect three color, two monomer colors and a donor color. For three color sequencing, the detectors of this invention would detect four color, three monomer colors and a donor color. For four color sequencing, the four monomer colors and a donor color. The interplay between the donor signal and the acceptor signals adds additional information for agent or tag interactive strategies such as FRET strategies.

The present invention broadly relates to an apparatus including: (a) a continuous substrate including zones including sparely distributed binding sites; (b) one component introduction station or a plurality of component introduction stations adapted to introduce one component or a plurality of components onto and/or into the zones and to form bound (immobilized) pre-reactive sites, (c) a mapping station adapted to locate isolated pre-reactive sites within a first viewing field comprising the entire zone or a portion thereof, (d) an initiation station adapted to introduce one initiator or a plurality of initiators onto and/or into the zones to form reactive sites, (e) a detection station adapted to monitor reaction events at one, some or all of the mapped reactive sites within a second viewing field comprising the entire zone or a portion thereof, and (f) an analyzer station adapted to receive signals from the mapping and detection stations and convert the signals into output data corresponding to and characterizing the detected events occurring within the detection station viewing field, where the continuous substrate is designed to be moved through the stations. In certain embodiment, the mapping and detection station can be the same. In most sequencing embodiments, the detector is capable of analyzing signals from each monomer type (each monomer type includes a unique fluorescent acceptor) and at least one additional signal, generally a fluorescent donor. For two color sequencing, the detectors of this invention would detect three color, two monomer colors and a donor color. For three color sequencing, the detectors of this invention would detect four color, three monomer colors and a donor color. For four color sequencing, the four monomer colors and a donor color. The interplay between the donor signal and the acceptor signals adds additional information for agent or tag interactive strategies such as FRET strategies.

The present invention broadly relates to method for detecting atomic, chemical or biochemical reactions at one atomic or molecular site or a plurality of sparsely distributed atomid or molecular sites including the steps of (a) providing a continuous substrate including zones having sparely distributed binding sites; (b) moving the continuous substrate so that a zone is aligned with one component introduction station or a plurality of component introduction stations adapted to introduce components sufficient to form a pre-reactive site or a plurality of bound sparely distributed pre-reactive sites, where each site includes at least one detectable agent including a detectable property, where the agents can be associated with the binding sites and/or one or more of the components of the sites; (c) moving the substrate so that the zone aligns with a mapping station adapted to map or locate detectable single pre-reactive sites inside a view field comprising the entire zone or a portion thereof; (d) moving the substrate so that the zone aligns with an initiation station adapted to introduce one initiator or a plurality of initiator onto and/or into the zones to form detectable reactive sites; (e) moving the substrate so that the zone aligns with a detection station adapted to detect reaction events at one, some or all of the located detectable reactive sites within a viewing field comprising the entire zone or a portion thereof; and (f) forwarding output signals from the mapping and the detection station to an analyzer adapted to receive signals from the mapping and detection stations and convert the signals into output data corresponding to and characterizing the detected events occurring with the viewing field. In most sequencing embodiments, the detector is capable of analyzing signals from each monomer type (each monomer type includes a unique fluorescent acceptor) and at least one additional signal, generally a fluorescent donor. For two color sequencing, the detectors of this invention would detect three color, two monomer colors and a donor color. For three color sequencing, the detectors of this invention would detect four color, three monomer colors and a donor color. For four color sequencing, the four monomer colors and a donor color. The interplay between the donor signal and the acceptor signals adds additional information for agent or tag interactive strategies such as FRET strategies.

In nucleotide sequencing reactions, the primer can include a blocking group, such as but not limited to a 3′ photo-labile or 3′ phosphate blocking group, so that dNTP incorporation reactions will not occur until the blocking group has been photocleaved or enzymatically removed. Thus, after the monomers are added to the zone including one or a plurality of pre-reactive sequencing complexes, sequencing will not occur until the zone is properly aligned in the detection station. Then, the zone can be either irradiated with light sufficient to photo-cleave or a phosphatase can be added to remove the blocking group on some or all of the primers. The detector can be on during photo-cleavage or phosphatase treatment so that the detector is on as sequencing reaction commence. Once the zone is moved into the detector station, the detector can map the pre-reactive sites so that when de-blocking occurs, the mapping is on the field being viewed. Alternatively or additionally, the template can include or have appended to its 3′ end a nucleotide sequence that will correspond to sequence immediately 3′ of the primer (the beginning of the sequence determined via the enzymatic activity of the molecular assemblage/sequencing complex) so that as the zone is moved into proper alignment in the detection station, the incorporation events will correspond to the sequence of the included or appended template sequence. The leader is of sufficient length to enable a ‘sequence accuracy check’ for the particular molecular assemblage (sequencing machine) that is being monitored, and will range from 4 to 20 or more nucleotides and include data checks for all nucleotide types that are being monitored in the reaction. The appended sequences may be used to differentially tag molecules for which information concerning their origin is relevant or otherwise desirable, such as but without limitation, two RNA or cDNA populations that correspond to different biological states (i.e., ‘normal’ or cancerous etc.).

In nucleotide sequencing reactions, the primer can include a 3′ photo-labile blocking group so that dNPT incorporation reaction will not occur until the blocking group has been photocleaved. Thus, after the monomers are added to the zone including one or a plurality of pre-reaction sequencing complexes, sequencing will not occur until the zone is properly aligned in the detection station. Then, the zone can be irradiated with light sufficient to photo-cleave the 3′ blocking group on some or all of the primers. The detector can be one during photo-cleavage so that the detector is on as sequencing reactions commence. Alternatively, the template can include a leader nucleotide sequence starting at the 3′ end of the primer so that as the zone is moved into proper alignment in the detection station, the incorporation events will correspond to the leader. The leader is of sufficient

### Sequencing

Bound Primer

The present invention also provides an apparatus for analyzing small, medium or large ensembles of active sequencing sites. The apparatus includes a substrate including a zone. The zone may include a surface or a matrix on which or in which are disposed one or a sparsely distributed plurality of nucleotide primer binding sites. The apparatus also includes primers immobilized to some or all of the primer binding sites, where the primers are adapted to form duplexes with a nucleic acid to be sequenced or a sparsely distributed plurality nucleic acids to be sequenced. The binding sites can also include a marker associated therewith so that each binding site can be located by the mapping station. The association can be a marker bonded to the binding site or can be bonded to a site of the zone proximate the binding sites. The binding sites can also be nano-particle donors such as fluorescently active and long lived quantum dots. The primers can also be the same or they can be different so that different templates can be simultaneously sequenced within the same zone. In certain embodiments, the zones are spaced apart along a length or along a length and a width of the substrate, while in other embodiments the zones are continuous.

The apparatus also includes a component delivery or introduction system adapted to introduce the nucleic acid or nucleic acids to be sequenced, a polymerizing agent and dNTPs for the polymerizing agent into the zone to convert some or all of the immobilized primers into immobilized active sequencing complexes. Alternatively, the nucleic acid is introduced first to convert some or all of the immobilized primers into immobilized primer/template duplexes. Then the polymerizing agent is introduced to convert some or all of the immobilized primer/template duplexes into immobilized pre-sequencing complexes. Then, the dNTPs for the polymerizing agent are added to convert some or all of the immobilized pre-active sequencing complexes into immobilized active sequencing complexes. Another alternative is to introduce the nucleic acid, template, and the polymerizing agent together, followed by dNTP introduction. The apparatus also includes a detector assembly adapted to detect: (a) a detectable property or changes in the property of an agent such as a tag or label associated with each of the pre-active sequencing complexes (bonded to one of the components, bonded to the binding sites or bonded to the zone in close proximity to the binding sites); (b) a detectable property or a change in the property of an agent such as a tag or label bonded to one or more of the dNTP types for the polymerizing agent; (c) a detectable property or a change in the property of an agent such as a tag or label bonded to a site on the dNTP that is released upon incorporation, a non-persistent agent such as a non-persistent tag or label, i.e., a tag or label bonded to a phosphate associated with the pyropyhosphate moiety of the dNTP—directly or after subsequence activation; (d) a detectable property or change in the property resulting from an interaction between a first agent such as a first tag or label associated with each primer/template/polymerizing complex and a second agent such as a second tag or label bonded to the dNTPs for the polymerizing agent; (e) a detectable property or a change in the property that becomes detectable after dNTP incorporation, e.g., the dNTP includes a persistent fluorophore and a non-persistent quencher or a persistent quencher and a non-persistent fluorophore; and (f) any other agent such as a tag or label that generates a detectable property that has different values before, during and/or after dNTP incorporation so that the incorporation events of some or all of the dNTP incorporations can be detected. The detector system is capable of detecting a change in the detectable property of the agent or agents before, during and/or after one or a plurality of monomer incorporation events. The detector system generally observes such events only within a field of view. This field of view can be the entire zone or, and generally, only a small portion of the zone. The apparatus also includes a means for moving the field or the zone in a controlled trajectory or manner, while detecting the incorporation events, sometimes referred to as detected events. This controlled motion of the viewing field or zone is adapted to improve detection and signal-to-noise ratio of the active sequencing sites. The apparatus also includes an analyzer capable of converting events detected by the detector into data relating to the detected events and to classify the events as correct incorporation event, mis-incorporation events, binding events, and collision events. In certain embodiments, each dNTP type includes a unique detectable agent and the detector system is capable of observing changes in the detectable property of each of the agents. In certain embodiments, each dNTP type includes a unique detectable fluorescent agent and the detector system is capable of observing changes in the fluorescence of each of the agents. In certain embodiments, each dNTP type includes a unique fluorescent acceptor and each primer/template/polymerizing agent complex, each binding agent or each site proximate each binding site includes a fluorescent donor and the detector system is capable of observing changes in the fluorescence of each of the acceptor and the donor, where the fluorescence of the acceptor is due to an interaction with the donor such as, but not limited to, a fluorescence resonance energy transfer (FRET) interaction or any other energy transfer procedure from a donor to an acceptor that results in acceptor fluorescence.

Bound Polymerizing Agent

The present invention also provides an apparatus for analyzing small, medium or large ensembles of active sequencing sites. The apparatus includes a substrate including a zone having disposed therein or thereon one binding site or a sparsely distributed plurality of polymerizing agent binding sites. The apparatus also includes polymerizing agents immobilized to some or all of the polymerizing agent binding sites within the zone, where the immobilized polymerizing agents are adapted to complex primer/template duplexes to form pre-active sequencing complexes or assemblages. The immobilization can be via non-covalent interactions or through a covalent bond. The apparatus also includes a component delivery system adapted to introduce the nucleic acids to be sequenced, a primer and dNTPs for the polymerizing agent to convert some or all of the immobilized polymerizing agent sites into immobilized active sequencing complexes or assemblages. Alternatively, primer/nucleic acid duplexes is introduced first to immobilized polymerizing agents to convert some or all of them into immobilized pre-sequencing complexes comprising an immobilized polymerizing agent complexed to a duplex. Then, the dNTPs for the polymerizing agent are added to convert some or all of the immobilized pre-active complexes into immobilized active complexes. The apparatus also includes a detector assembly adapted to detect: (a) a detectable property or changes in the property of an agent such as a tag or label associated with each of the pre-active sequencing complexes (bonded to one of the components, bonded to the binding sites or bonded to the zone in close proximity to the binding sites); (b) a detectable property or a change in the property of an agent such as a tag or label bonded to one or more of the dNTP types for the polymerizing agent; (c) a detectable property or a change in the property of an agent such as a tag or label bonded to a site on the dNTP that is released upon incorporation, a non-persistent agent such as a non-persistent tag or label, i.e., a tag or label bonded to a phosphate associated with the pyropyhosphate moiety of the dNTP—directly or after subsequence activation; (d) a detectable property or change in the property resulting from an interaction between a first agent such as a first tag or label associated with each primer/template/polymerizing complex and a second agent such as a second tag or label bonded to the dNTPs for the polymerizing agent; (e) a detectable property or a change in the property that becomes detectable after dNTP incorporation, e.g., the dNTP includes a persistent fluorophore and a non-persistent quencher or a persistent quencher and a non-persistent fluorophore; and (f) any other agent such as a tag or label that generates a detectable property that has different values before, during and/or after dNTP incorporation so that the incorporation events of some or all of the dNTP incorporations can be detected. The detector system is capable of detecting a change in the detectable property of the agent or agents before, during and/or after one or a plurality of monomer incorporation events. The detector system generally observes such events only with a field of view. This field of view can be the entire zone or, and generally, only a small portion of the zone. The apparatus also includes a means for moving the field or the zone in a controlled trajectory or manner, while detecting the incorporation events, sometimes referred to as detected events. This controlled motion of the viewing field or zone is adapted to improve detection and signal-to-noise ratio of the active sequencing sites. The apparatus also includes an analyzer capable of converting events detected by the detector into data relating to the detected events and to classify the events as correct incorporation event, mis-incorporation events, binding events, and collision events. In certain embodiments, each dNTP type includes a unique detectable agent and the detector system is capable of observing changes in the detectable property of each of the agents. In certain embodiments, each dNTP type includes a unique detectable fluorescent agent and the detector system is capable of observing changes in the fluorescence of each of the agents. In certain embodiments, each dNTP type includes a unique fluorescent acceptor and each primer/template/polymerizing agent complex, each binding agent or each site proximate each binding site includes a fluorescent donor and the detector system is capable of observing changes in the fluorescence of each of the acceptor and the donor, where the fluorescence of the acceptor is due to an interaction with the donor such as, but not limited to, a fluorescence resonance energy transfer (FRET) interaction or any other energy transfer mechanism from a donor to an acceptor that results in acceptor fluorescence.

Bound Nucleic Acid, Template

The present invention also provides an apparatus for analyzing small, medium or large ensembles of active sequencing sites. The apparatus includes a substrate having a zone. The zone has disposed therein or thereon one template binding site or a sparsely distributed plurality of template binding sites within the zone to which immobilized sites comprising an immobilized nucleic acid to be sequenced or template. The immobilization can be via non-covalent interactions or through a covalent bond. The apparatus also includes a component delivery system adapted to introduce a primer, a polymerizing agent, and dNTPs for the polymerizing agent to convert some or all of the immobilized templates into active sequencing complexes. Alternatively, a primer is introduced first so that the primer pre-associates with some or all of the immobilized template to form immobilized primer/template duplexes. Next, the polymerizing agent is added to convert some or all of the immobilized primer/template duplexes into immobilized pre-active sequencing complexes. And finally, the dNTPs for the polymerizing agent are added to convert some or all of the immobilized pre-active sequencing complexes into immobilized active sequencing complexes. The apparatus also includes a detector assembly adapted to detect: (a) a detectable property or changes in the property of an agent such as a tag or label associated with each of the pre-active sequencing complexes (bonded to one of the components, bonded to the binding sites or bonded to the zone in close proximity to the binding sites); (b) a detectable property or a change in the property of an agent such as a tag or label bonded to one or more of the dNTP types for the polymerizing agent; (c) a detectable property or a change in the property of an agent such as a tag or label bonded to a site on the dNTP that is released upon incorporation, a non-persistent agent such as a non-persistent tag or label, i.e., a tag or label bonded to a phosphate associated with the pyropyhosphate moiety of the dNTP—directly or after subsequence activation; (d) a detectable property or change in the property resulting from an interaction between a first agent such as a first tag or label associated with each primer/template/polymerizing complex and a second agent such as a second tag or label bonded to the dNTPs for the polymerizing agent; (e) a detectable property or a change in the property that becomes detectable after dNTP incorporation, e.g., the dNTP includes a persistent fluorophore and a non-persistent quencher or a persistent quencher and a non-persistent fluorophore; and (f) any other agent such as a tag or label that generates a detectable property that has different values before, during and/or after dNTP incorporation so that the incorporation events of some or all of the dNTP incorporations can be detected. The detector system is capable of detecting a change in the detectable property of the agent or agents before, during and/or after one or a plurality of monomer incorporation events. The detector system generally observes such events only within a field of view. This field of view can be the entire zone or, and generally, only a small portion of the zone. The apparatus also includes a means for moving the field or the zone in a controlled trajectory or manner, while detecting the incorporation events, sometimes referred to as detected events. This controlled motion of the viewing field or zone is adapted to improve detection and signal-to-noise ratio of the active sequencing sites. The apparatus also includes an analyzer capable of converting events detected by the detector into data relating to the detected events and to classify the events as correct incorporation event, mis-incorporation events, binding events, and collision events. In certain embodiments, each dNTP type includes a unique detectable agent and the detector system is capable of observing changes in the detectable property of each of the agents. In certain embodiments, each dNTP type includes a unique detectable fluorescent agent and the detector system is capable of observing changes in the fluorescence of each of the agents. In certain embodiments, each dNTP type includes a unique fluorescent acceptor and each primer/template/polymerizing agent complex, each binding agent or each site proximate each binding site includes a fluorescent donor and the detector system is capable of observing changes in the fluorescence of each of the acceptor and the donor, where the fluorescence of the acceptor is due to an interaction with the donor such as, but not limited to, a fluorescence resonance energy transfer (FRET) interaction or any other energy transfer mechanism from a donor to an acceptor that results in acceptor fluorescence.

Bound Donor Structures

The present invention also provides an apparatus for analyzing small, medium or large ensembles of active sequencing sites. The apparatus includes a substrate having a zone. The zone has disposed therein or thereon one donor structure binding agent or a sparsely distributed plurality of donor structure binding agent within the zone to which immobilized sites comprising an immobilized donor structure will be formed. The immobilization can be via non-covalent interactions or through a covalent bond. The donor structure includes at least one component binding agent adapted to immobilize a primer, a template or a polymerizing agent. The apparatus also includes a component delivery system adapted to introduce a primer, a template, or a polymerizing agent to immobilize the primer, template or polymerizing agent to the immobilized donor structures. Alternatively, the substrate can have the donor structures formed directly on or into the substrate zone. In most embodiments, the polymerizing agents are immobilized to the donor structures and not the template or the primer to keep the active site in the same general position relative to the donor structure. Next, the other components are introduced either individually or collectively to form immobilized polymerizing/primer-template duplex complexes or pre-active sequencing complexes or sites. Finally, the dNTPs for the polymerizing agent are added to convert some or all of the immobilized pre-active sequencing complexes into immobilized active sequencing complexes or sites. The apparatus also includes a detector assembly adapted to detect: (a) a detectable property or changes in the property of an agent such as a tag or label associated with each of the pre-active sequencing complexes (bonded to one of the components, bonded to the binding sites or bonded to the zone in close proximity to the binding sites); (b) a detectable property or a change in the property of an agent such as a tag or label bonded to one or more of the dNTP types for the polymerizing agent; (c) a detectable property or a change in the property of an agent such as a tag or label bonded to a site on the dNTP that is released upon incorporation, a non-persistent agent such as a non-persistent tag or label, i.e., a tag or label bonded to a phosphate associated with the pyropyhosphate moiety of the dNTP—directly or after subsequence activation; (d) a detectable property or change in the property resulting from an interaction between a first agent such as a first tag or label associated with each primer/template/polymerizing complex and a second agent such as a second tag or label bonded to the dNTPs for the polymerizing agent; (e) a detectable property or a change in the property that becomes detectable after dNTP incorporation, e.g., the dNTP includes a persistent fluorophore and a non-persistent quencher or a persistent quencher and a non-persistent fluorophore; and (f) any other agent such as a tag or label that generates a detectable property that has different values before, during and/or after dNTP incorporation so that the incorporation events of some or all of the dNTP incorporations can be detected. The detector system is capable of detecting a change in the detectable property of the agent or agents before, during and/or after one or a plurality of monomer incorporation events. The detector system generally observes such events only with a field of view. This field of view can be the entire zone or, and generally, only a small portion of the zone. The apparatus also includes a means for moving the field or the zone in a controlled trajectory or manner, while detecting the incorporation events, sometimes referred to as detected events. This controlled motion of the viewing field or zone is adapted to improve detection and signal-to-noise ratio of the active sequencing sites. The apparatus also includes an analyzer capable of converting events detected by the detector into data relating to the detected events and to classify the events as correct incorporation event, mis-incorporation events, binding events, and collision events. In certain embodiments, each dNTP type includes a unique detectable agent and the detector system is capable of observing changes in the detectable property of each of the agents. In certain embodiments, each dNTP type includes a unique detectable fluorescent agent and the detector system is capable of observing changes in the fluorescence of each of the agents. In certain embodiments, each dNTP type includes a unique fluorescent acceptor and each primer/template/polymerizing agent complex, each binding agent or each site proximate each binding site includes a fluorescent donor and the detector system is capable of observing changes in the fluorescence of each of the acceptor and the donor, where the fluorescence of the acceptor is due to an interaction with the donor such as a fluorescence resonance energy transfer (FRET) interaction. Although most embodiments of this invention are directed to interactions between donor and acceptor detectable agents that result in acceptor fluorescence that result from fluorescent resonance energy transfer (FRET), the donor structures can electronically excite the acceptors by other energy transfer mechanism. A FRET strategy is generally preferred because the donor and acceptors can be simultaneously observed and their intensity should anti-correlated when an energy transfer occurs. Although the immobilized donor structure substrates can be performed in a moving stage format it can also be performed in a stationary stage format due to an increased signal-to-noise ratio when using substrates including immobilized the donor structures.

### Surface-QuntumDot-Enzyme Model

Quantum dots (QD) are attractive donor structures that are long living donor and can be immobilized and used to as immobilization anchor for a component of a pre-sequencing complex, primer, template or polymerizing agent. In most embodiment, the QD is used to immobilize the polymerizing agent so that the two structures can be held in the same or substantially the same configuration during active sequencing. One immobilization scheme is shown below:

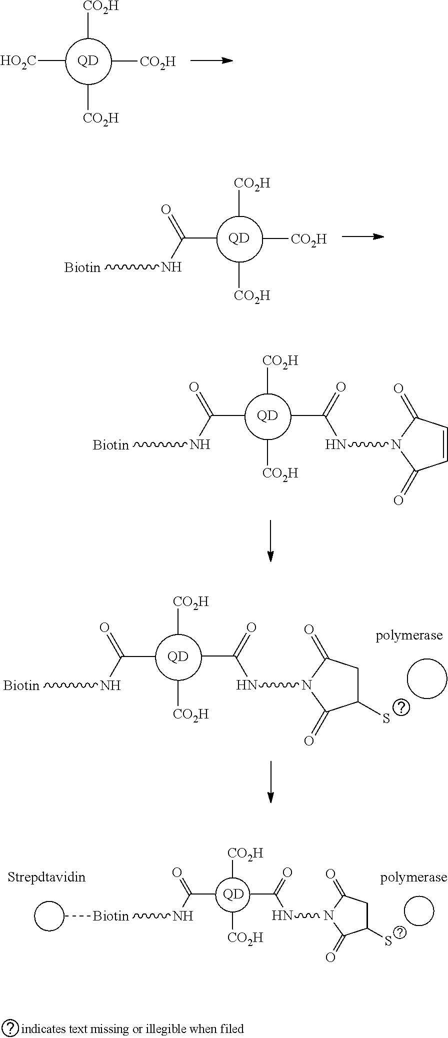

Method Using a Continuous Film

The present invention also provides a method for analyzing small ensembles of active sites or single active site in a continuous reaction mode, an intermittent reaction mode, a periodic reaction mode, semi-periodic reaction mode, or mixed mode (a mixture of one or more of the other modes in any combination or permutation). The method includes the steps of providing a continuous substrate comprising a film including zones. Each zone includes one bound component or a plurality of sparsely distributed bound components, where the components can be bound to a binding agent pre-formed in or on the zones or the components can be formed on or in the zones. The method can include the step of moving a zone so that it aligns with one station or a plurality of stations adapted to introduce other components to form pre-active or active sites in the zones. Next, the zone is moved into alignment with a first detector station adapted to locate or map single pre-active or active sites within or inside a viewing field of the zone relative to a grid corresponding to pixels associated with a detector such as a camera of the first detection station. The viewing field can be the entire zone or a portion of the zone. Once the zone has been mapped at the first detection station and if the zone includes pre-active sites, then the zone can be moved into alignment with an initiation station adapted to introduce one or a plurality of initiators onto and/or into the zone, where some or all of the bound pre-active sites are converted into active sites. Once the active sites are formed, the zone is moved into alignment with a second detector station adapted to monitor reaction events occurring at one, some or all of the mapped sites within or inside the viewing field. During detection of the detectable events, the zone or viewing field is moved in controlled manner to improve location of active sites (detectable atomic site, molecules, complexes or assemblages), improve signal recognition, improve noise identification and reduction, and/or improve signal-to-noise ratio. Finally, the method includes the step of sending the event data to an analyzer adapted to convert the event data into output data corresponding to the detected events. Each site, binding site and/or a component of the zone proximate each site includes at least one agent having a detectable property, where multiple agents can be the same or different and in the case of multiple agents, the agents can be interactive or non-interactive. Of course, the method can include multiple stations so that a plurality of zones can be simultaneously processed. Alternatively, the method can be repeated for a plurality of zones by repeating the zone activation and detection steps until a desired number of zones are processed.

Method Using a Disk

The present invention also provides a method for analyzing small ensembles of active sites or single active site in a continuous reaction mode, an intermittent reaction mode, a periodic reaction mode, semi-periodic reaction mode, or mixed mode (a mixture of one or more of the other modes in any combination or permutation). The method includes to steps of providing a continuous substrate comprising a disk including zones. Each zone includes one bound component or a plurality of sparsely distributed bound components, where the components can be bound to a binding agent pre-formed in or on the zones or the components can be formed on or in the zones. The method can include the step of moving a zone so that it aligns with one station or a plurality of stations adapted to introduce other components to form pre-active or active sites in the zones. Next, the zone is moved into alignment with a first detector station adapted to locate or map single pre-active or active sites within or inside a viewing field of the zone relative to a grid corresponding to pixels associated with a detector such as a camera of the first detection station. The viewing field can be the entire zone or a portion of the zone. Once the zone has been mapped at the first detection station and if the zone includes pre-active sites, then the zone can be moved into alignment with an initiation station adapted to introduce one or a plurality of initiators onto and/or into the zone, where some or all of the bound pre-active sites are converted into active sites. Once the active sites are formed, the zone is moved into alignment with a second detector station adapted to monitor reaction events occurring at one, some or all of the mapped sites within or inside the viewing field. During detection of the detectable events, the zone or viewing field is moved in controlled manner to improve location of active sites (detectable atomic site, molecules, complexes or assemblages), improve signal recognition, improve noise identification and reduction, and/or improve signal-to-noise ratio. Finally, the method includes the step of sending the event data to an analyzer adapted to convert the event data into output data corresponding to the detected events. Each site, binding site and/or a component of the zone proximate each site includes at least one agent having a detectable property, where multiple agents can be the same or different and in the case of multiple agents, the agents can be interactive or non-interactive. Of course, the method can include multiple stations so that a plurality of zones can be simultaneously processed. Alternatively, the method can be repeated for a plurality of zones by repeating the zone activation and detection steps until a desired number of zones are processed.

For additional information on DNA sequencing, data acquisition and analysis, monomers, monomers synthesis, or other features of system that are amenable to detection using the apparatuses and methods of this invention, the reader is referred to United States patent, Published patent application and Pending patent application Ser. Nos. 09/901,782; 10/007,621; 11/007,794; 11/671,956; 11/694,605; 2006-0078937; U.S. Pat. Nos. 6,982,146; 7,169,560; 7,220,549, 20070070349; 20070031875; 20070012113; 20060286566; 20060252077; 20060147942; 200601336144; 20060024711; 20060024678; 20060012793; 20060012784; 20050100932; incorporated herein by reference.

Although the apparatuses and method described above are illustrated using polymerizing agents so that the events being detected are events that result in the formation of oligomeric or polymeric products at least for those system that produce a sequence specific product, the apparatus and methods can be equally well be applied to depolymerizing system where an oligomer or polymer is depolymerized step wise with each removed monomer unit being detected before, during and/or after remove to permit identification of the removed monomer.

### Suitable Reagents

Suitable substrates include, without limitation, flexible substrates or rigid substrates, where the substrates have disposed on one surface: (1) sparsely distributed bonding sites for immobilizing one or more precursor reagents, (2) a single layered or multi-layered matrix including sparsely distributed bonding sites therein or in/on the top layer; (3) a continuous matrix including sparsely distributed bonding sites therein/thereon; (4) a heterogeneous matrix including sparsely distributed bonding sites therein/thereon; or (5) any other coating on the substrate surface that can support sparsely distributed bonding sites therein/thereon. The term sparsely as used therein means that the sites are spaced apart sufficient that resulting immobilized pre-reactive molecular assemblages can be separately and distinctly detected and monitored in the apparatus. The distribution can be random or patterned. The substrates may also be chips or other microelectronic devices.

Suitable flexible substrates include any polymer having sufficient strength to be wound and unwound on to reels or can pulled through a single pass apparatus and being transparent to light within the detection range. Suitable polymers include, without limitation, polyolefins, polyacrylates, polystyrenes, polyamides, polyimides, polyalkylene oxides, polyacids, polycarbonates, polylactones, or any other structure plastic or polymer.

Suitable rigid substrates include glass, ceramics, metals, or other rigid materials. Suitable glasses include quartz or any glass or mixtures or combinations thereof. Suitable ceramics include silicates, aluminates, silica-aluminas, alumina-silicas, titania-alumina-silicates, zirconates, titanates, or any other ceramic substrate. Suitable metals include any metal substrate that can support bonding sites and/or layers or matrices.

Suitable polymerizing agents for use in this invention include, without limitation, any polymerizing agent that polymerizes monomers relative to a specific template such as a DNA or RNA polymerase, reverse transcriptase, or the like or that polymerizes monomers in a step-wise fashion.

Suitable polymerases for use in this invention include, without limitation, any polymerase that can be isolated from its host in sufficient amounts for purification and use and/or genetically engineered into other organisms for expression, isolation and purification in amounts sufficient for use in this invention such as DNA or RNA polymerases that polymerize DNA, RNA or mixed sequences, into extended nucleic acid polymers. In certain embodiments, polymerases for use in this invention include mutants or mutated variants of native polymerases where the mutants have one or more amino acids replaced by amino acids amenable to attaching an atomic or molecular tag, which have a detectable property. Exemplary DNA polymerases include, without limitation, HIV1-Reverse Transcriptase using either RNA or DNA templates, DNA pol I from T. aquaticus or E. coli, Bateriophage T4 DNA pol, T7 DNA pol, phi29, any other isolated and available polymerase or transcriptase, variants of any these polymerases, or the like. Exemplary RNA polymerases include, without limitation, T7 RNA polymerase or the like.

Suitable depolymerizing agents for use in this invention include, without limitation, any depolymerizing agent that depolymerizes monomers in a step-wise fashion such as exonucleases in the case of DNA, RNA or mixed DNA/RNA polymers, proteases in the case of polypeptides and enzymes or enzyme systems that sequentially depolymerize polysaccharides.

Suitable monomers for use in this invention include, without limitation, any monomer that can be step-wise polymerized into a polymer using a polymerizing agent. Suitable nucleotides for use in this invention include, without limitation, naturally occurring nucleotides, synthetic analogs thereof, analog having atomic and/or molecular tags attached thereto, or mixtures or combinations thereof.

Suitable detectable agents include, without limitation, any group that is detectable by a known or yet to be invented analytical technique. Exemplary examples include, without limitation, fluorophores or chromophorers, group including one or a plurality of nmr active atoms (²H, ¹¹B, ¹³C, ¹⁵N, ¹⁷O, ¹⁹F, ²⁷Al, ²⁹Si, ³¹P, nmr active transition metals, nmr active actinide metals, nmr active lanthanide metals), IR active groups, nearIR active groups, Raman active groups, UV active groups, X-ray active groups, light emitting quantum dots, light emitting nano-structures, or other structures or groups capable of direct detection or that can be rendered detectable or mixtures or combinations thereof.

Suitable atomic tag for use in this invention include, without limitation, any atomic element or structure or system amenable to being attached to a specific site in a polymerizing agent or dNTP, especially Europium shift agents, nmr active atoms or the like.

Suitable molecular tag for use in this invention include, without limitation, any molecule amenable to being attached to a specific site in a polymerizing agent or monomer, especially fluorescent dyes such as d-Rhodamine acceptor dyes including dichloro[R110], dichloro[R6G], dichloro[TAMRA], dichloro[ROX] or the like, fluorescein donor dye including fluorescein, 6-FAM, or the like; Acridine including Acridine orange, Acridine yellow, Proflavin, or the like; Aromatic Hydrocarbon including 2-Methylbenzoxazole, Ethyl p-dimethylaminobenzoate, Phenol, benzene, toluene, or the like; Arylmethine Dyes including Auramine O, Crystal violet, Crystal violet, Malachite Green or the like; Coumarin dyes including 7-Methoxycoumarin-4-acetic acid, Coumarin 1, Coumarin 30, Coumarin 314, Coumarin 343, Coumarin 6 or the like; Cyanine Dye including 1,1′-diethyl-2,2′-cyanine iodide, Cryptocyanine, Indocarbocyanine (C3)dye, Indodicarbocyanine (C5)dye, Indotricarbocyanine (C7)dye, Oxacarbocyanine (C3)dye, Oxadicarbocyanine (C5)dye, Oxatricarbocyanine (C7)dye, Pinacyanol iodide, Stains all, Thiacarbocyanine (C3)dye, Thiacarbocyanine (C3)dye, Thiadicarbocyanine (C5)dye, Thiatricarbocyanine (C7)dye, or the like; Dipyrrin dyes including N,N′-Difluoroboryl-1,9-dimethyl-5-(4-iodophenyl)-dipyrrin, N,N′-Difluoroboryl-1,9-dimethyl-5-[(4-(2-trimethylsilylethynyl), N,N′-Difluoroboryl-1,9-dimethyl-5-phenydipyrrin, or the like; Merocyanines including 4-(dicyanomethylene)-2-methyl-6-(p-dimethylaminostyryl)-4H-pyran (DCM), 4-(dicyanomethylene)-2-methyl-6-(p-dimethylaminostyryl)-4H-pyran (DCM), 4-Dimethylamino-4′-nitrostilbene, Merocyanine 540, or the like; Miscellaneous Dye including 4′,6-Diamidino-2-phenylindole (DAPI), 4′,6-Diamidino-2-phenylindole (DAPI), 7-Benzylamino-4-nitrobenz-2-oxa-1,3-diazole, Dansyl glycine, Dansyl glycine, Hoechst 33258, Hoechst 33258, Lucifer yellow CH, Piroxicam, Quinine sulfate, Quinine sulfate, Squarylium dye III, or the like; Oligophenylenes including 2,5-Diphenyloxazole (PPO), Biphenyl, POPOP, p-Quaterphenyl, p-Terphenyl, or the like; Oxazines including Cresyl violet perchlorate, Nile Blue, Nile Red, Nile blue, Oxazine 1, Oxazine 170, or the like; Polycyclic Aromatic Hydrocarbons including 9,10-Bis(phenylethynyl)anthracene, 9,10-Diphenylanthracene, Anthracene, Naphthalene, Perylene, Pyrene, or the like; polyene/polyenes including 1,2-diphenylacetylene, 1,4-diphenylbutadiene, 1,4-diphenylbutadiyne, 1,6-Diphenylhexatriene, Beta-carotene, Stilbene, or the like; Redox-active Chromophores including Anthraquinone, Azobenzene, Benzoquinone, Ferrocene, Riboflavin, Tris(2,2′-bipyridyl)ruthenium(II), Tetrapyrrole, Bilirubin, Chlorophyll a, Chlorophyll b, Diprotonated-tetraphenylporphyrin, Hematin, Magnesium octaethylporphyrin, Magnesium octaethylporphyrin (MgOEP), Magnesium phthalocyanine (MgPc), Magnesium phthalocyanine (MgPc), pyridine, Magnesium tetramesitylporphyrin (MgTMP), Magnesium tetraphenylporphyrin (MgTPP), Octaethylporphyrin, Phthalocyanine (Pc), Porphin, Tetra-t-butylazaporphine, Tetra-t-butylnaphthalocyanine, Tetrakis(2,6-dichlorophenyl)porphyrin, Tetrakis(o-aminophenyl)porphyrin, Tetramesitylporphyrin (TMP), Tetraphenylporphyrin (TPP), Vitamin B12, Zinc octaethylporphyrin (ZnOEP), Zinc phthalocyanine (ZnPc), Zinc tetramesitylporphyrin (ZnTMP), Zinc tetramesitylporphyrin radical cation, Zinc tetraphenylporphyrin (ZnTPP), or the like; Cy3, Cy3B, Cy5, Cy5.5, Atto590, Atto610, Atto611, Atto611x, Atto620, Atto655, Alexa488, Alexa546, Alexa594, Alexa610, Alexa610x, Alexa633, Alexa647, Alexa660, Alexa680, Alexa700, Bodipy630, DY610, DY615, DY630, DY632, DY634, DY647, DY680, DyLight647, HiLyte647, HiLyte680, LightCycler (LC) 640, Oyster650, ROX, TMR, TMR5, TMR6; Xanthenes including Eosin Y, Fluorescein, Fluorescein, Rhodamine 123, Rhodamine 6G, Rhodamine B, Rose bengal, Sulforhodamine 101, or the like; or mixtures or combination thereof or synthetic derivatives thereof or FRET fluorophore-quencher pairs including DLO-FB1 (5′-FAM/3′-BHQ-1) DLO-TEB1 (5′-TET/3′-BHQ-1), DLO-JB1 (5′-JOE/3′-BHQ-1), DLO-HB1 (5′-HEX/3′-BHQ-1), DLO-C3B2 (5′-Cy3/3′-BHQ-2), DLO-TAB2 (5′-TAMRA/3′-BHQ-2), DLO-RB2 (5′-ROX/3′-BHQ-2), DLO-05B3 (5′-Cy5/3′-BHQ-3), DLO-055B3 (5′-Cy5.5/3′-BHQ-3), MBO-FB1 (5′-FAM/3′-BHQ-1), MBO-TEB1 (5′-TET/3′-BHQ-1), MBO-JB1 (5′-JOE/3′-BHQ-1), MBO-HB1 (5′-HEX/3′-BHQ-1), MBO-C3B2 (5′-Cy3/3′-BHQ-2), MBO-TAB2 (5′-TAMRA/3′-BHQ-2), MBO-RB2 (5′-ROX/3′-BHQ-2); MBO-05B3 (5′-Cy5/3′-BHQ-3), MBO-055B3 (5′-Cy5.5/3′-BHQ-3) or similar FRET pairs available from Biosearch Technologies, Inc. of Novato, Calif., fluorescent quantum dots (stable long lived fluorescent donors), tags with nmr active groups, Raman active tags, tags with spectral features that can be easily identified such as IR, far IR, near IR, visible UV, far UV or the like. It should be recognized that any molecule, nano-structure, or other chemical structure that is capable of chemical modification and includes a detectable property capable of being detected by a detection system. Such detectable structure can include one presently known and structures that are being currently designed and those that will be prepared in the future.

### Substrates

General

The apparatuses of the invention are designed to utilized a continuous, semi-continuous or discontinuous substrate including zones having disposed therein and/or thereon one or a plurality of bound components, where the components can be binding sites, markers, donors such as quantum dots, or a component of the atomic or molecular site. The zones can be continuous or discrete. The zones can be spaced apart along a length or along a length and width of the substrate. The terms continuous means that the substrate extends laterally such as a tape made of a polymeric film, an extended length of a ceramic substrate, or a similar extended material onto which a zone or zones can be formed. In most embodiments, the zone or zones include binding agents or sites capable of binding and immobilizing one or a plurality of components that will make up an active site, where the binding sites are sparsely distributed within the zone or zones. The distribution can be either random or patterned. The distribution is formed in such a way that one, some or all of the resulting active sites are detectably distinct one from the other. The distributions are designed so that a majority of the binding sites will support only a single active site, atomic system, molecule, complex or assemblage, which is detectably distinct from all other active sites. The substrate can include one or a plurality of continuous zones that extend the length or width of the substrate. The substrate can include zones patterned on the substrate or randomly distributed on the substrate.

Films

The substrate can be a film. The film can be polymeric, ceramic or metallic with zones being transparent to the wavelength of light used for excitation and/or detection.

Rigid Linear Substrate

The substrate can be a rigid linear substrate on which the zones are formed. The rigid substrate can include recessed areas in which the zones are formed or disposed. The substrate can be any rigid material with zones being transparent to the wavelength of light used for excitation and/or detection.

Rigid Disk Substrate

The substrate can be in the shape of a disk, with the zones either spiraling out from its center or in the form of concentric rings. The apparatus can include stations disposed on armatures that permit the stations to move linearly outward as the disk is rotated much as phonograph operated in a forward and reverse direction.

The substrates are designed to be used with any single molecule detection format. For certain detection formats, the substrate must be transparent to light in a desired wavelength range. The zones can be signed to operate in a total internal reflectance fluorescence (TIRF) mode, a zero mode waveguide (ZMW) detection mode or other time of detection modes that require specialized substrate and zones formed within the substrate.

### Suitable Detection System

Suitable single molecule detection systems or methodologies that can be detected in the apparatuses of this invention includes, without limitation, those described in United States patent and patent application Ser. No. 09/901,782 filed Jul. 9, 2001; Ser. No. 10/007,621 filed Dec. 3, 2001; Ser. No. 11/089,822 filed Mar. 25, 2005; Ser. Nos. 09/572,530; 11/089,871 filed Mar. 25, 2005; Ser. No. 11/089,875 filed Mar. 25, 2005; Ser. No. 10/358,818; U.S. Pat. Nos. 7,056,676; 7,056,661; 7,052,847; 7,033,764; 7,018,819; 6,989,235; 6,985,223; 6,982,165; 6,982,149; 6,962,778; 6,936,702; 6,927,065; 6,919,333; 6,869,764; 6,858,436; 6,828,786; 6,818,395; 6,811,977; 6,790,671; 6,767,716; 6,762,048; 6,762,025; 6,743,578; 6,723,552; 6,714,294; 6,649,404; 6,635,470; 6,632,609; 6,608,314; 6,608,228; 6,607,888; 6,573,089; 6,537,755; 6,528,258; 6,455,861; 6,448,015; 6,403,311; 6,388,746; 6,369,928; 6,355,420; 6,331,617; 6,329,150; 6,316,229; 6,313,914; 6,306,607; 6,296,810; 6,287,772; 6,287,765; 6,274,313; 6,267,913; 6,265,166; 6,255,083; 6,248,518; 6,232,075; 6,226,082; 6,221,592; 6,210,896; 6,143,495; 6,110,676; 6,049,380; 5,898,493; 5,674,743; 5,646,731; 5,558,998; 5,538,850; 5,514,596; 5,437,840; 5,405,747; 5,329,461; 5,322,796; 20060154288; 20060147942; 20060147941; 20060147927; 20060141531; 20060141268; 20060136144; 20060134679; 20060134666; 20060126921; 20060121442; 20060118754; 20060109546; 20060109461; 20060103840; 20060099648; 20060098927; 20060098705; 20060094030; 20060078998; 20060078937; 20060078915; 20060077382; 20060072114; 20060068440; 20060063264; 20060063173; 20060062531; 20060062440; 20060061762; 20060061755; 20060061754; 20060057606; 20060054982; 20060050268; 20060046313; 20060046311; 20060046291; 20060046258; 20060033038; 20060024678; 20060019276; 20060019267; 20060019263; 20060017918; 20060014191; 20060012793; 20060012784; 20060008799; 20060008227; 20060003333; 20050282173; 20050281682; 20050280817; 20050279927; 20050276535; 20050272159; 20050266584; 20050266583; 20050266478; 20050266456; 20050266424; 20050260653; 20050260614; 20050255580; 20050244863; 20050244821; 20050238286; 20050233417; 20050221510; 20050221509; 20050221508; 20050221506; 20050221408; 20050221319; 20050213090; 20050208574; 20050208557; 20050208491; 20050207018; 20050206892; 20050202468; 20050202466; 20050202464; 20050196790; 20050186619; 20050186576; 20050181383; 20050181379; 20050180678; 20050176228; 20050176029; 20050170367; 20050164264; 20050164255; 20050164205; 20050164181; 20050158877; 20050158761; 20050153354; 20050153284; 20050147992; 20050147980; 20050147979; 20050147977; 20050147976; 20050147963; 20050142595; 20050142567; 20050136419; 20050130150; 20050123974; 20050123944; 20050112671; 20050112620; 20050112595; 20050112579; 20050110990; 20050089993; 20050089924; 20050089920; 20050089901; 20050089890; 20050087122; 20050084980; 20050074779; 20050074774; 20050069895; 20050053974; 20050053966; 20050048581; 20050048498; 20050042665; 20050042649; 20050042639; 20050042633; 20050042615; 20050031545; 20050027166; 20050019784; 20050014175; 20050009004; 20050003376; 20050003359; 20040265392; 20040262636; 20040259094; 20040259082; 20040252957; 20040248161; 20040248144; 20040246572; 20040241681; 20040234958; 20040224325; 20040217297; 20040215087; 20040214221; 20040214211; 20040196569; 20040191778; 20040181344; 20040174521; 20040166593; 20040166514; 20040161369; 20040151631; 20040146849; 20040142386; 20040137510; 20040135997; 20040126790; 20040120455; 20040115838; 20040110208; 20040101891; 20040099813; 20040096981; 20040096887; 20040091903; 20040082080; 20040080750; 20040077090; 20040077075; 20040072200; 20040065806; 20040053399; 20040046120; 20040043506; 20040042937; 20040029288; 20040019104; 20040014033; 20040012780; 20040009612; 20040009510; 20040005613; 20040005582; 20030235900; 20030235854; 20030235849; 20030231304; 20030228682; 20030219765; 20030215864; 20030215844; 20030206297; 20030203502; 20030194740; 20030190647; 20030186276; 20030186255; 20030186227; 20030181658; 20030174992; 20030174923; 20030173647; 20030166851; 20030165929; 20030162181; 20030160151; 20030158474; 20030149153; 20030148344; 20030146091; 20030143614; 20030143549; 20030143219; 20030138831; 20030134807; 20030134794; 20030134298; 20030124592; 20030124576; 20030123883; 20030123155; 20030123058; 20030121764; 20030119168; 20030119002; 20030104588; 20030100102; 20030098248; 20030096231; 20030095893; 20030095259; 20030092005; 20030068629; 20030065155; 20030064400; 20030064366; 20030059820; 20030054396; 20030054181; 20030052006; 20030044781; 20030040173; 20030036204; 20030026735; 20030008372; 20030008295; 20020197736; 20020197735; 20020197639; 20020196442; 20020192649; 20020187508; 20020182651; 20020182627; 20020168678; 20020167665; 20020164629; 20020160400; 20020150938; 20020143167; 20020137057; 20020126276; 20020123050; 20020119455; 20020118005; 20020115076; 20020110843; 20020105641; 20020104759; 20020102596; 20020102595; 20020102568; 20020098124; 20020094526; 20020081744; 20020081605; 20020070349; 20020061526; 20020058273; 20020058256; 20020052040; 20020042071; 20020039738; 20020039737; 20020034757; 20020030811; 20020025529; 20020013250; 20020012933; 20020012930; 20020001810; 20020001768; 20010018184; 20010007985; 20010002315; 20060154288; 20060141531; 20060134666; 20060098927; 20060094030; 20060078937; 20060063264; 20060063173; 20060062531; 20060061755; 20060061754; 20060057606; 20060046291; 20060019267; 20060014191; 20060008799; 20060008227; 20060003333; 20050280817; 20050266584; 20050266583; 20050266424; 20050260614; 20050244821; 20050221408; 20050208557; 20050208491; 20050202466; 20050186619; 20050170367; 20050164255; 20050164205; 20050158761; 20050089901; 20050089890; 20050074779; 20050048581; 20050042633; 20050031545; 20040265392; 20040262636; 20040259082; 20040252957; 20040246572; 20040241681; 20040174521; 20040166514; 20040151631; 20040096887; 20040072200; 20040043506; 20040019104; 20040014033; 20030235854; 20030235849; 20030215844; 20030203502; 20030194740; 20030186255; 20030174923; 20030165929; 20030158474; 20030143614; 20030134807; 20030124592; 20030104588; 20030092005; 20030064400; 20030064366; 20030054181; 20030044781; 20020192649; 20020168678; 20020167665; 20020164629; 20020137057; 20020126276; 20020119455; 20020115076; 20020104759; 20020102596; 20020070349; 20020052040; 20020042071; 20020039738; 20020034757; 20020013250; 20010018184; 7,076,092; 7,060,419; 7,056,676; 7,056,670; 7,056,661; 7,052,847; 7,052,616; 7,049,148; 7,041,812; 7,038,856; 7,033,781; 7,033,764; 7,019,828; 7,018,819; 7,013,054; 6,995,348; 6,992,300; 6,989,897; 6,989,542; 6,989,235; 6,985,223; 6,982,165; 6,982,149; 6,982,146; 6,980,294; 6,972,173; 6,970,239; 6,962,778; 6,944,407; 6,939,663; 6,936,702; 6,934,030; 6,932,940; 6,929,779; 6,927,070; 6,927,065; 6,919,333; 6,917,726; 6,916,665; 6,911,345; 6,882,767; 6,869,764; 6,858,436; 6,850,323; 6,846,638; 6,844,154; 6,841,096; 6,838,121; 6,828,800; 6,828,786; 6,828,100; 6,818,959; 6,818,395; 6,811,977; 6,809,816; 6,806,455; 6,794,659; 6,790,671; 6,787,308; 6,781,690; 6,771,367; 6,767,716; 6,762,059; 6,762,048; 6,762,025; 6,761,962; 6,760,109; 6,759,247; 6,749,813; 6,743,578; 6,723,552; 6,714,294; 6,713,260; 6,707,548; 6,696,299; 6,689,529; 6,685,885; 6,685,810; 6,673,577; 6,669,906; 6,649,683; 6,649,404; 6,635,470; 6,632,609; 6,610,649; 6,610,504; 6,608,716; 6,608,314; 6,608,228; 6,607,888; 6,603,546; 6,599,703; 6,582,907; 6,582,903; 6,573,089; 6,537,755; 6,529,275; 6,528,801; 6,528,258; 6,524,829; 6,515,120; 6,459,093; 6,455,861; 6,453,245; 6,448,015; 6,438,279; 6,432,361; 6,428,667; 6,426,231; 6,418,382; 6,410,239; 6,403,311; 6,395,478; 6,391,559; 6,388,746; 6,387,234; 6,381,025; 6,376,180; 6,376,177; 6,375,871; 6,369,928; 6,355,420; 6,331,617; 6,329,150; 6,316,229; 6,313,914; 6,310,352; 6,306,607; 6,296,810; 6,287,772; 6,287,765; 6,280,933; 6,274,320; 6,274,313; 6,267,913; 6,265,166; 6,258,568; 6,258,533; 6,255,083; 6,255,048; 6,248,518; 6,246,046; 6,232,075; 6,231,812; 6,226,082; 6,221,592; 6,218,657; 6,210,896; 6,210,891; 6,204,068; 6,190,889; 6,190,868; 6,180,415; 6,177,277; 6,143,496; 6,143,495; 6,141,657; 6,140,041; 6,110,676; 6,083,693; 6,057,101; 6,049,380; RE36,529; 6,004,771; 6,002,471; 6,001,566; 5,972,693; 5,958,673; 5,945,312; 5,898,493; 5,885,813; 5,871,697; 5,866,331; 5,858,671; 5,834,204; 5,827,663; 5,804,384; 5,799,682; 5,763,162; 5,754,511; 5,674,743; 5,658,749; 5,646,731; 5,614,365; 5,558,998; 5,538,850; 5,528,368; 5,514,596; 5,437,840; 5,405,747; 5,377,003; 5,329,461; 5,322,796; 4,979,824; 4,962,037; 7,067,644; 7,056,676; 7,056,661; 7,056,659; 7,052,847; 7,049,074; 7,033,781; 7,033,764; 6,713,263; 6,610,256; 6,509,158; 6,485,625; 6,448,065; 6,448,012; 6,306,607; 6,296,810; 6,294,136; 6,246,046; 6,245,506; 6,236,945; 6,218,121; 6,150,089; 6,147,198; 6,017,434; 6,015,902; 6,001,566; 5,993,634; 5,968,784; 5,808,077; 5,720,928; 5,674,743; 5,624,845; 5,609,744; 20060057606; 20050255477; 20050227235; 20050208557; 20050202466; 20050186619; 20050164255; 20050158761; 20050155861; 20040077090; 20030124611; 20030092005; 20030044781; 20030036067; 20030027201; 20020173045; and 20020132349, incorporated herein by reference.

In certain embodiments, the detection system suitable for use in nucleic acid sequencing should be capable of detecting light from three, four, or five different sources—two color, three color and four color sequencing, where the additional color correspond to a donor color or to a marker color. The detection system can include up to one camera or detector per color. Thus, a two color sequencer could include one, two or three cameras or detectors; a three color sequencer could include one, two, three or four cameras or detectors; and a four color sequencer could include one, two, three, four or five cameras or detectors. However, if a FRET-based strategy is not used, then the detection system is ideally composed of cameras or detectors corresponding to the number of different types of detectable monomer in the reaction, although detection can be accomplished with fewer camera or detector units.

### DETAILED DESCRIPTION OF THE DRAWINGS

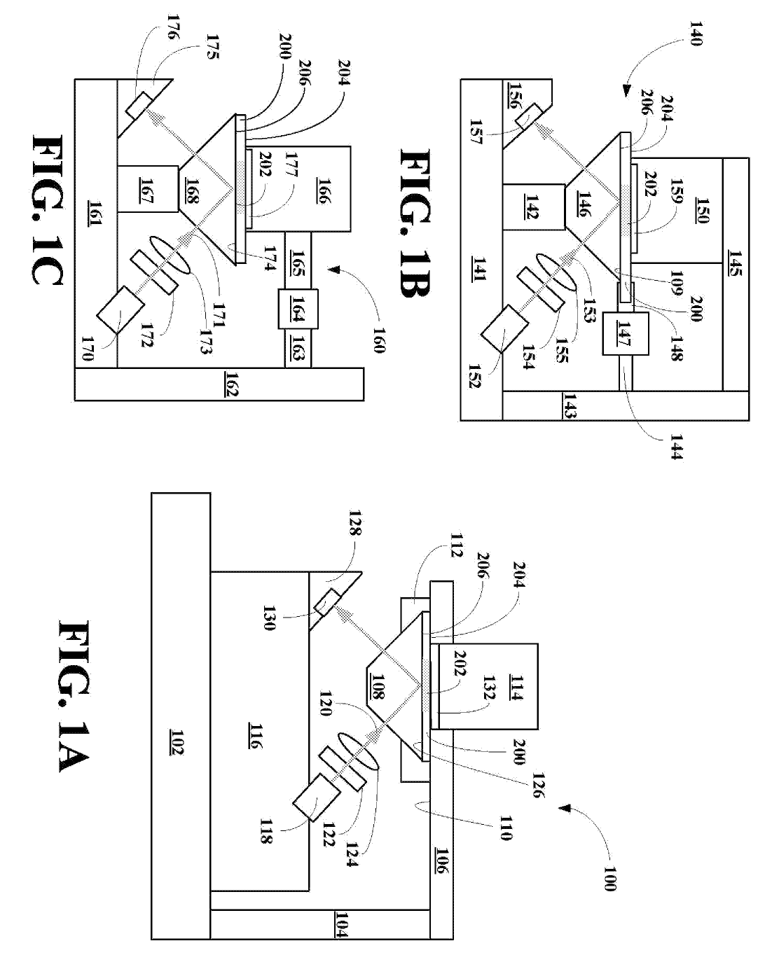

Referring now to FIG. 1A, an embodiment of an apparatus for monitoring single molecule or single molecular assemblage events of this invention, generally 100, is shown to include a substrate 300 including one or a plurality of zones 302 having disposed therein and/or thereon active single sites comprising atomic systems, molecules, molecular complexes or molecular assemblages, where the zone or one or more of the molecular components includes at least one detectable agent, each agent having a detectable property that undergoes a change before, during and/or after a reaction and/or interaction, many reactions and/or interaction, or a series or sequence of reactions and/or interactions. This apparatus 100 is adapted for single molecule detection in a fluorescence format. However, the apparatus 100 can be adapted to other detection formats such as IR, Raman, NMR, etc.

The apparatus 100 includes a base 102 including a support column 104 and an arm 106. The arm 106 supports the substrate 300, a dove prism 108 disposed on a bottom 110 of the arm 106 via a prism mount 112 and a detector 114. The dove prism 108 is adapted to deliver the incident light at the critical angle for TIRF at the substrate/aqueous interface such that only the fluorescent complexes within the zone will receive evanescent excitation energy. An alternative would be to use a through-the-lens system, thereby avoiding the need for a prism. The apparatus 100 also includes a movable platform 116. The platform 116 supports a light source 118 adapted to generate incident light beam 120 of a specific frequency range, a filter 122 adapted to narrow the frequency range of the incident light, and a lens 124 adapted to focus the light beam 120 onto the zone(s) 302 through the dove prism 108 having a long side 126 positioned proximate a back side 306 of the substrate 300. It should be recognized by ordinary artisans that the light source 118 can be designed without the filter 122 and/or the lens 124 depending on the type of light source used, e.g., a laser may not need the filter and/or lens, while a broad band light source would require the filter and lens. The platform 116 also includes a light absorption block 128 including a light port 130 adapted to absorb non-absorbed incident light reflected from or by the substrate 300.

Operationally, the incident light 120 impinges on the zone(s) 302, where it excites fluorescent tags associated with, in proximity to or bonded to all reactive single molecule sites within the zone(s) 302. Fluorescent light emitted by active sites in the zone(s) 302 passes through an objective lens 132 of the detector 114 held proximate a top substrate side 304 of the substrate 300, which captures images of the fluorescent light emitted within a viewing field of the detector, where the viewing field can comprise the entire the zone 302 or a portion thereof. The detector 114 can includes an analyzer or can be in data communication with an analyzer (not shown), where the detector 114 and analyzer are adapted to detect detectably discernible single molecule, single molecular or single molecular assemblage sites in the zone(s) 302 and detect reactions and/or interactions occurring at the sites over a period of time. At the interface between the objective 132 and the substrate 300 and between the prism 108 and the substrate 300, the apparatus may includes oil films or inert gas films with desired indices of fractions to facilitate excitation and detection by limiting the volume of excitation. TIRF and other surface irradiation techniques can be used to achieve small volume irradiation.

As the detection is occurring, the platform 116 is moved in a controlled manner or trajectory so that the active sites within the viewing field of the detector 114 move in a corresponding controlled manner or trajectory. The motion improves site identification and/or registration, signal detection, noise reduction, and signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

The apparatus can include sample introduction assemblies (not shown) for adding components to the zone. In certain embodiments, at least one of the reaction components is immobilized or confined in or on the zones. In the case of immobilization, at least one of the components is non-covalently or covalently bonded to binding agents sparsely distributed in or one the zone. In certain embodiment, a fluorescent donor, such as but not limited to, a quantum dot or nanocrystal or other energy transferring nanostructure, is used to immobilize the molecular assemblage in or on the zone of the substrate, where the donor is immobilized on or in the zone. The donor is also linked, either directly or through an adapter type of molecule, to the polymerizing agent, such as the polymerase. The linkage between the surface and the donor and between the donor and the molecular assemblage can be either the same or different. In a preferred embodiment, the linkage between the surface and the donor is through a strepavidin (surface)-biotin (donor) interaction and the linkage between the donor and the polymerase is through thiol coupling. In the case of confinement, at least one component or the entire reacting assembly is confined within a volume that reduces Brownian motion such as nano-channels or nano-wells. The component introduction assembly can be via pipettes or via controlled injector connected to component reservoirs. All components can be added at once or the components can be added in stages. In certain embodiments, components are added to form pre-reactive sites in the zone(s), where at least one component or the zone includes a detectable group that can be detected prior to reaction start to identify pre-reactive sites. Components can then be added to initiate reaction. The detector then continuously accumulates images at desired rate recording the changes in the detectable property over time. In other embodiments, the initiating components also include a detectable agent and the reactions are evidenced by an interaction between the agents so that both agents undergo a change in their detectable property during a reaction cycle, e.g., FRET.

Referring now to FIG. 1B, another embodiment of an apparatus for monitoring single molecule or single molecular assemblage events of this invention, generally 140, is shown to include a sample 300 including one or a plurality of zones 302 having disposed therein and/or thereon active single molecules, molecular complexes or molecular assemblages, where the zone or one or more of the molecular components includes a detectable group having a detectable property that undergoes a change during a molecular reaction and/or interaction. This apparatus 140 is adapted for single molecule detection in a fluorescence format.

The apparatus 140 includes a base 141 including a prism support 142, a support column 143, a first arm 144 and a second arm 145. The prism support 142 supports a dove prism 146. The first arm 144 supports a substrate motor 147, which supports a substrate mount 148 into which one end of the substrate 300 is inserted. The second arm 145 supports a detector 150. The base 141 also supports a light source 152 adapted to generate incident light beam 153 of a specific frequency range, a filter 154 adapted to narrow the frequency range of the incident light, and a lens 155 adapted to focus the light beam 153 onto the zone(s) 302 through the dove prism 152 having a long side 109 positioned proximate a back side 306 of the substrate 300. It should be recognized by ordinary artisans that the light source can be designed without the filter 154 and/or the lens 155 depending on the type of light source used, e.g., a laser may not need the filter and/or lens, while a broad band light source would require the filter and lens. The base 142 also supports a light absorption block 156 including a light port 157 adapted to absorb non-absorbed incident light reflected from or by the substrate 300.

Operationally, the incident light 120 impinges on the zone(s) 302, where it excites fluorescent tags associated with, in proximity to or bonded to all reactive single molecule sites within the zone(s) 302. Fluorescent light emitted by active sites in the zone(s) 302 passes through an objective lens 159 of the detector 158 held proximate the zone side 304 of the substrate 300, which captures images of the fluorescent light emitted within a view field of the detector within the zone(s) 302. The detector 150 can includes an analyzer or can be in data communication with an analyzer, where the detector 150 and analyzer are adapted to detect detectably discernible single molecule, single molecular or single molecular assemblage sites in the zone(s) 302 and detect reactions and/or interactions occurring at the sites over a period of time. At the interface between the objective and the substrate and between the prism and the substrate, the apparatus may includes oil film or inert gas film with desired index of fraction properties to facilitate excitation and detection by limiting the volume of excitation. TIRF and other surface irradiation techniques can be used to achieve small volume irradiation.

As detection is occurring, the motor 147 and mount 148 move the substrate 300 in a controlled trajectory so that active molecular sites within the zone move relative to the viewing field of the detector to image in a controlled trajectory so that the active sites with in the viewing field of the detector 150 move in a corresponding controlled trajectory. The motion improves site identification and/or registration, signal detection, noise reduction, and improved signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

The apparatus can include sample introduction assemblies (not shown) for adding components to the zone. In certain embodiments, at least one of the reaction components is immobilized or confined in or on the zones. In the case of immobilization, at least one of the components is non-covalently or covalently bonded to binding agents sparsely distributed in the zone. In the case of confinement, at least one component or the entire reacting assembly is confined within a volume that reduces Brownian motion such as nano-channels or nano-wells. The component introduction assembly can be via pipettes or via controlled injector connected to component reservoirs. All components can be added at once or the components can be added in stages. In certain embodiments, components are added to form pre-reactive sites in the zone(s), where at least one component or the zone includes a detectable group that can be detected prior to reaction start to identify pre-reactive sites. Components can then be added to initiate reaction. The detector would then continuously accumulated images at desired rate of changes in the detectable property. In other embodiments, the initiating components also include a detectable group and the reactions are evidence by an interaction between the groups so that both groups undergo a change in a detectable property during a reaction cycle, e.g., FRET.

Referring now to FIG. 1C, another embodiment of an apparatus for monitoring single molecule or single molecular assemblage events of this invention, generally 160, is shown to include a sample 300 including one or a plurality of zones 302 having disposed therein and/or thereon active single molecules, molecular complexes or molecular assemblages, where the zone or one or more of the molecular components includes a detectable group having a detectable property that undergoes a change during a molecular reaction and/or interaction. This apparatus 100 is adapted for single molecule detection in a fluorescence format.

The apparatus 100 includes a base 161 including a support column 162 and an arm 163. The arm 163 supports a motor 164, which supports a detector support 165 which in turn support a detector 166. The base 161 also supports a prism support 167 on which is mounted a dove prism 168. The base 161 also supports a light source 170 adapted to generate incident light beam 171 of a specific frequency range, a filter 172 adapted to narrow the frequency range of the incident light, and a lens 173 adapted to focus the light beam 171 onto the zone(s) 302 through the dove prism 183 having a long side 174 positioned proximate a back side 306 of the substrate 300. It should be recognized by ordinary artisans that the light source can be designed without the filter 172 and/or the lens 173 depending on the type of light source used, e.g., a laser may not need the filter and/or lens, while a broad band light source would require the filter and lens. The base 161 also includes a light absorption block 175 including a light port 176 adapted to absorb non-absorbed incident light reflected from or by the substrate 300.

Operationally, the incident light 120 impinges on the zone(s) 302, where it excites fluorescent tags associated with, proximity to, or bonded to all reactive single molecule sites within the zone(s) 302. Fluorescent light emitted by active sites in the zone(s) 302 passes through an objective lens 177 of the detector 166 held proximate the zone side 304 of the substrate 300, which captures images of the fluorescent light emitted within a view field of the detector within the zone(s) 302. The detector 166 can includes an analyzer or can be in data communication with an analyzer, where the detector 166 and analyzer are adapted to detect detectably discernible single molecule, single molecular or single molecular assemblage sites in the zone(s) 302 and detect reactions and/or interactions occurring at the sites over a period of time. At the interface between the objective and the substrate and between the prism and the substrate, the apparatus may includes oil film or inert gas film with desired index of fraction properties to facilitate excitation and detection by limiting the volume of excitation. TIRF and other surface irradiation techniques can be used to achieve small volume irradiation.

As the detection is occurring, the motor 164 moves the detector support 165 and in turn the detector 166 in a controlled trajectory so that the active sites with in the viewing field of the detector 166 move in a corresponding controlled trajectory. The motion improves site identification and/or registration, signal detection, noise reduction, and improved signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

The apparatus can include sample introduction assemblies (not shown) for adding components to the zone. In certain embodiments, at least one of the reaction components is immobilized or confined in or on the zones. In the case of immobilization, at least one of the components is non-covalently or covalently bonded to binding agents sparsely distributed in the zone. Preferably, a fluorescent donor, such as but not limited to a quantum dot or nanocrystal, is used to immobilize the molecular assemblage to the surface, and the donor is additionally linked, either directly or through an adapter type of molecule, to the polymerizing agent, such as the polymerase. The linkage between the surface and the donor and between the donor and the molecular assemblage can be either the same or different. In a preferred embodiment, the linkage between the surface and the donor is through a strepavidin (surface)-biotin (donor) interaction and the linkage between the donor and the polymerase is through thiol coupling. In the case of confinement, at least one component or the entire reacting assembly is confined within a volume that reduces Brownian motion such as nano-channels or nano-wells. The component introduction assembly can be via pipettes or via controlled injector connected to component reservoirs. All components can be added at once or the components can be added in stages. In certain embodiments, components are added to form pre-reactive sites in the zone(s), where at least one component or the zone includes a detectable group that can be detected prior to reaction start to identify pre-reactive sites. Components can then be added to initiate reaction. The detector then continuously accumulates images at desired rate of changes in the detectable property. In other embodiments, the initiating components also include a detectable agent and the reactions are evidence by an interaction between the agents so that both agents undergo a change in a detectable property during a reaction cycle, e.g., FRET.

If the optical system is based on internal reflectance methods such as TIRF or ATR, then the mirrored objective lens are not needed and the light is simply reflected based on angle of incident and on a different in index of refraction. Generally, the index of refraction difference is established between the zone material of the film, disk or rigid substrate and an oil film on the prism surface that is separated from the zone by a cover slip or by a gap of an inert gas.

The light beam does not enter the solution. The dove prism adjusts the path of the beam such that it strikes the substrate-aqueous interface at the critical angle for total internal reflection. The incident beam is reflected at the substrate-aqueous interface, and the reaction complexes bound to the substrate are excited by evanescent energy generated by the reflected incident light. In this way, only fluorophores located within ˜50 nm of the substrate-aqueous interface. Fluorescent events occur only within the zone.

As an alternative embodiment, the apparatus will use through-the-objective lens TIRF system in which the laser excitation energy is delivered through the objective lens located on the opposite (inert) side of the substrate (where the dove prisms are located in FIG. 1A-C) and at the critical angle for total internal reflection at the substrate-aqueous interface. This embodiment is preferred for some applications, because it limits excitation to the field of view of the lens.

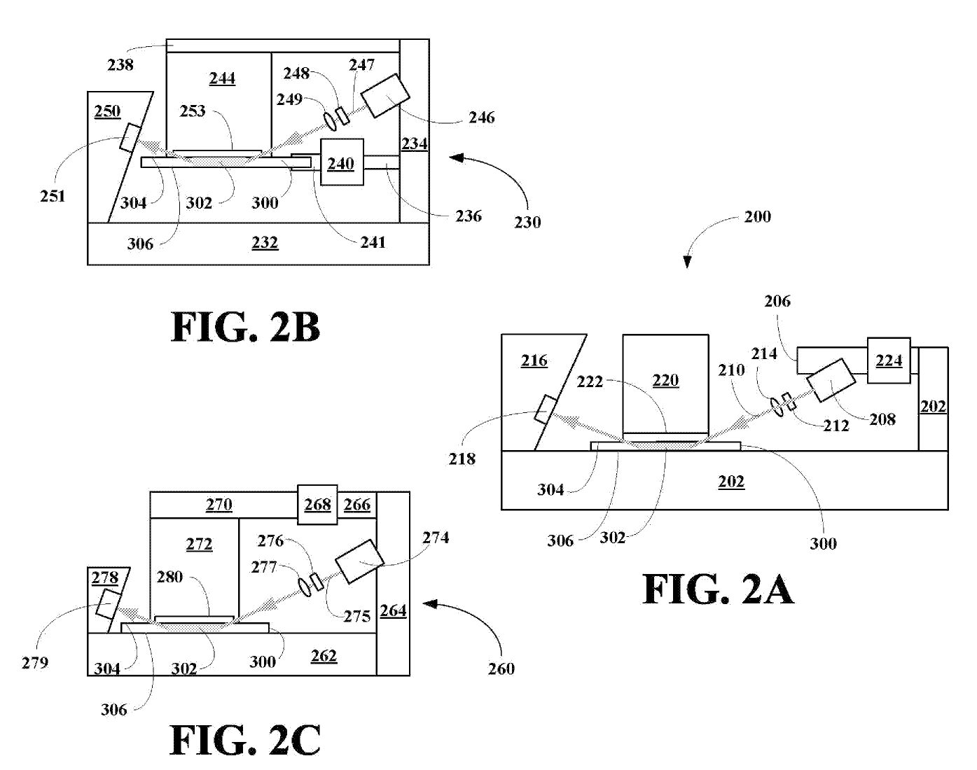

Referring now to FIG. 2A, a through the objective embodiment of an apparatus for monitoring single molecule or single molecular assemblage events of this invention, generally 200, is shown to include a substrate 300 including one or a plurality of zones 302 having disposed therein and/or thereon active single sites comprising atomic systems, molecules, molecular complexes or molecular assemblages, where the zone or one or more of the molecular components includes at least one detectable agent, each agent having a detectable property that undergoes a change before, during and/or after a reaction and/or interaction, many reactions and/or interaction, or a series or sequence of reactions and/or interactions. This apparatus 200 is adapted for single molecule detection in a fluorescence format. However, the apparatus 200 can be adapted to other detection formats such as IR, Raman, NMR, etc.

The apparatus 200 also includes a base 202 including a support column 204 and an arm 206. The arm 106 supports a light source 208 adapted to generate incident light beam 210 of a specific frequency range, a filter 212 adapted to narrow the frequency range of the incident light, and a lens 214 adapted to focus the light beam 210 onto the zone(s) 302 at a critical angle to support TIRF. The substrate 300 includes a top side 304 and a back side 306. It should be recognized by ordinary artisans that the light source 208 can be designed without the filter 212 and/or the lens 214 depending on the type of light source used, e.g., a laser may not need the filter and/or lens, while a broad band light source would require the filter and lens. The base 202 also includes a light absorption block 216 including a light port 218 adapted to absorb non-absorbed incident light reflected from, passing through or reflected by the substrate 300. The apparatus 200 also includes a detector 220.

Operationally, the incident light 210 impinges on the zone(s) 302 in a TIRF format, where it excites fluorescent tags associated with, in proximity to or bonded to all reactive single molecule sites within the zone(s) 302. Fluorescent light emitted by active sites in the zone(s) 302 passes through an objective lens 222 of the detector 220 held proximate a top substrate side 304 of the substrate 300, which captures images of the fluorescent light emitted within a viewing field of the detector, where the viewing field can comprise the entire the zone 302 or a portion thereof. The detector 220 can includes an analyzer or can be in data communication with an analyzer (not shown), where the detector 220 and analyzer are adapted to detect detectably discernible single molecule, single molecular or single molecular assemblage sites in the zone(s) 302 and detect reactions and/or interactions occurring at the sites over a period of time. At the interface between the objective 222 and the substrate 300, the apparatus may includes oil films or inert gas films with desired indices of fractions to facilitate excitation and detection by limiting the volume of excitation. TIRF and other surface irradiation techniques can be used to achieve small volume irradiation.

The arm 202 also include a motor 224, where the motor 224 is designed to move the light source 208 in a controlled manner or trajectory so that the active sites within the viewing field of the detector 220 move in a corresponding controlled manner or trajectory. The motion improves site identification and/or registration, signal detection, noise reduction, and signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

Referring now to FIG. 2B, another through the objective embodiment of an apparatus for monitoring single molecule or single molecular assemblage events of this invention, generally 230, is shown to a base 232 including a support column 234, a first arm 236 and a second arm 238. The first arm 236 supports a substrate motor 240, which supports a substrate mount 241 into which one end of the substrate 300 is inserted. The second arm 238 supports a detector 244. The column 234 also supports a light source 246 adapted to generate incident light beam 247 of a specific frequency range, a filter 248 adapted to narrow the frequency range of the incident light, and a lens 249 adapted to focus the light beam 247 onto the zone(s) 302 at a critical angle to support TIRF. The substrate 300 includes a top side 304 and a back side 306. It should be recognized by ordinary artisans that the light source can be designed without the filter 248 and/or the lens 249 depending on the type of light source used, e.g., a laser may not need the filter and/or lens, while a broad band light source would require the filter and lens. The base 322 also supports a light absorption block 250 including a light port 251 adapted to absorb non-absorbed incident light reflected from or by the substrate 300.

Operationally, the incident light 247 impinges on the zone(s) 302 in a TIRF format, where it excites fluorescent tags associated with, in proximity to or bonded to all reactive single molecule sites within the zone(s) 302. Fluorescent light emitted by active sites in the zone(s) 302 passes through an objective lens 253 of the detector 244 held proximate the zone side 304 of the substrate 300, which captures images of the fluorescent light emitted within a view field of the detector within the zone(s) 302. The detector 244 can includes an analyzer or can be in data communication with an analyzer, where the detector 244 and analyzer are adapted to detect detectably discernible single molecule, single molecular or single molecular assemblage sites in the zone(s) 302 and detect reactions and/or interactions occurring at the sites over a period of time. At the interface between the objective and the substrate and between the prism and the substrate, the apparatus may includes oil film or inert gas film with desired index of fraction properties to facilitate excitation and detection by limiting the volume of excitation. TIRF and other surface irradiation techniques can be used to achieve small volume irradiation.

As detection is occurring, the motor 240 and mount 241 move the substrate 300 in a controlled trajectory so that active molecular sites within the zone move relative to the viewing field of the detector to image in a controlled trajectory so that the active sites with in the viewing field of the detector 244 move in a corresponding controlled trajectory. The motion improves site identification and/or registration, signal detection, noise reduction, and improved signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

Referring now to FIG. 2C, another through the objective embodiment of an apparatus for monitoring single molecule or single molecular assemblage events of this invention, generally 260, is shown to include a base 262 including a support column 264 and an arm 266. The base 262 supports the substrate 300 including the zone 302. The substrate 300 includes a top side 304 and a back side 306. The arm 266 supports a motor 268, which supports a detector support 270 which in turn support a detector 272. The arm 266 also supports a light source 274 adapted to generate incident light beam 275 of a specific frequency range, a filter 276 adapted to narrow the frequency range of the incident light, and a lens 277 adapted to focus the light beam 277 onto the zone(s) 302 at a critical angle to support TIRF. It should be recognized by ordinary artisans that the light source 274 can be designed without the filter 276 and/or the lens 277 depending on the type of light source used, e.g., a laser may not need the filter and/or lens, while a broad band light source would require the filter and lens. The base 262 also includes a light absorption block 278 including a light port 279 adapted to absorb non-absorbed incident light reflected from or by the substrate 300.

Operationally, the incident light 277 impinges on the zone(s) 302 in a TIRF format, where it excites fluorescent tags associated with, proximity to, or bonded to all reactive single molecule sites within the zone(s) 302. Fluorescent light emitted by active sites in the zone(s) 302 passes through an objective lens 280 of the detector 272 held proximate the zone side 304 of the substrate 300, which captures images of the fluorescent light emitted within a view field of the detector within the zone(s) 302. The detector 272 can includes an analyzer or can be in data communication with an analyzer, where the detector 272 and analyzer are adapted to detect detectably discernible single molecule, single molecular or single molecular assemblage sites in the zone(s) 302 and detect reactions and/or interactions occurring at the sites over a period of time. At the interface between the objective and the substrate and between the prism and the substrate, the apparatus may includes oil film or inert gas film with desired index of fraction properties to facilitate excitation and detection by limiting the volume of excitation. TIRF and other surface irradiation techniques can be used to achieve small volume irradiation.

As the detection is occurring, the motor 164 moves the detector support 165 and in turn the detector 166 in a controlled trajectory so that the active sites with in the viewing field of the detector 166 move in a corresponding controlled trajectory. The motion improves site identification and/or registration, signal detection, noise reduction, and improved signal-to-noise ratio. However, stage or imaging movement does not have to occur during the sequence detection step. The next field of view can be brought into the detecting chamber after data collection is completed from the previous field of view, and this process can be repeated 10, 100, 1000, 10000, or 1000000 or more times from a substrate containing immobilized molecular assemblages.

In either case, the objective lens projects an image of the distribution of reaction complexes onto a cooled CCD chip that is incorporated into a digital imaging device such as a digital camera. This imaging system measures the fluorescence intensity at each pixel onto which the light from an individual reaction complex is projected (as determined at the mapping station).

The light path and detection events are now described. Laser light is directed to prism at an adjustable angle. The refracted beam then passes through the surface of the long side of the prism. Next, the beam passes through an oil film having a refractive index that matches the refractive index of the substrate. The beam, then, passes through the substrate and encounters the substrate-aqueous interface at a critical angle adapted to support total internal reflection of incident light (reflected beam is directed to a photodiode for intensity determination). The beam results in the generation of an evanescent wave that excites fluors associated with the complexes bound to the substrate. The excited fluors then emit photons some of which pass through the solution, across the quartz window, through the oil film and the front glass of the objective lens. These photons are then collected by the objective lens and an image of the reactive surface is projected onto a detector such as a CCD or iCCD camera, or a cooled CCD camera or iCCD camera.

This image is compared with the image of the distribution of single reaction sites detected at the mapping station, and only those pixels detect light from regions of the substrate that we determined to contain single reaction sites (at the mapping station) are used for data (sequence) analysis.

### Experiments of the Invention

### Condition for the Moving Stage Experiments

Motorized microscope XY stage “Proscan” from Prior scientific was used for the experiments. Stage was controlled by MetaMorph.

Stage Conditions

(1) MotorAccelleration—0; (2) Acceleration Rate—0; (3) Increments—0.1 μm; (4) Servo was disabled. (5) Rate of movement—1; and (6) Speed of movement ˜8 pixel/sec or that corresponds to 22 sec per field.

Collection Conditions

(1) Setup—Argon laser based TIRF; (2) Camera—Cascade512; (3) Software—Metamorph; (4) Number of Frames—3000; and (5) Duration—150 sec.

Sample Conditions

(1) Static FRET Between Alexa 488/Cy5 on Duplex.

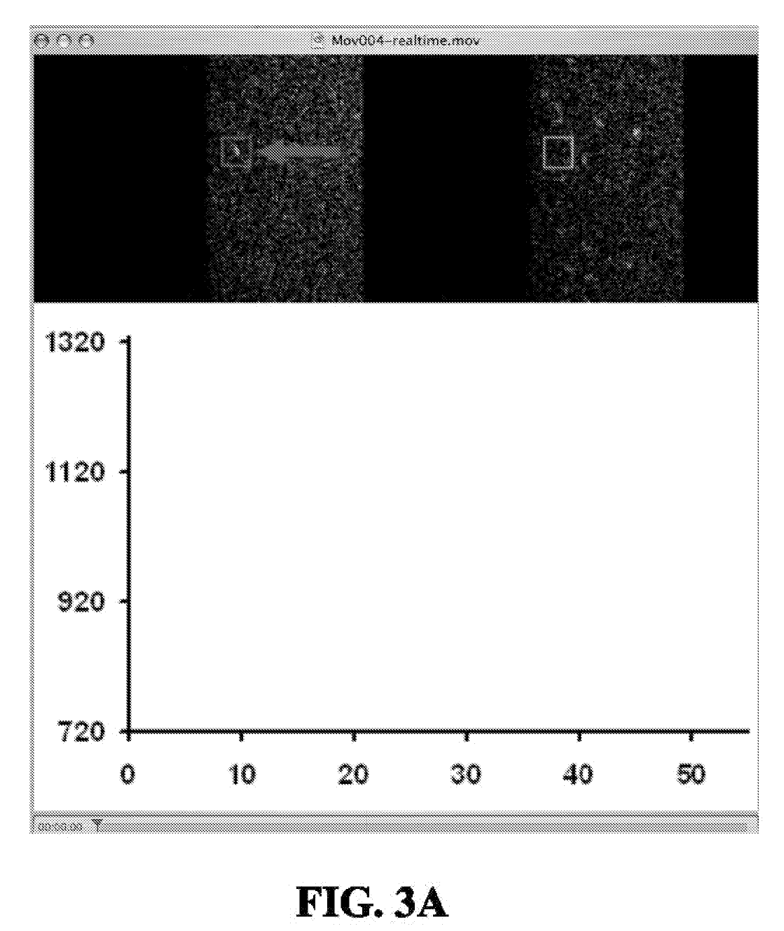

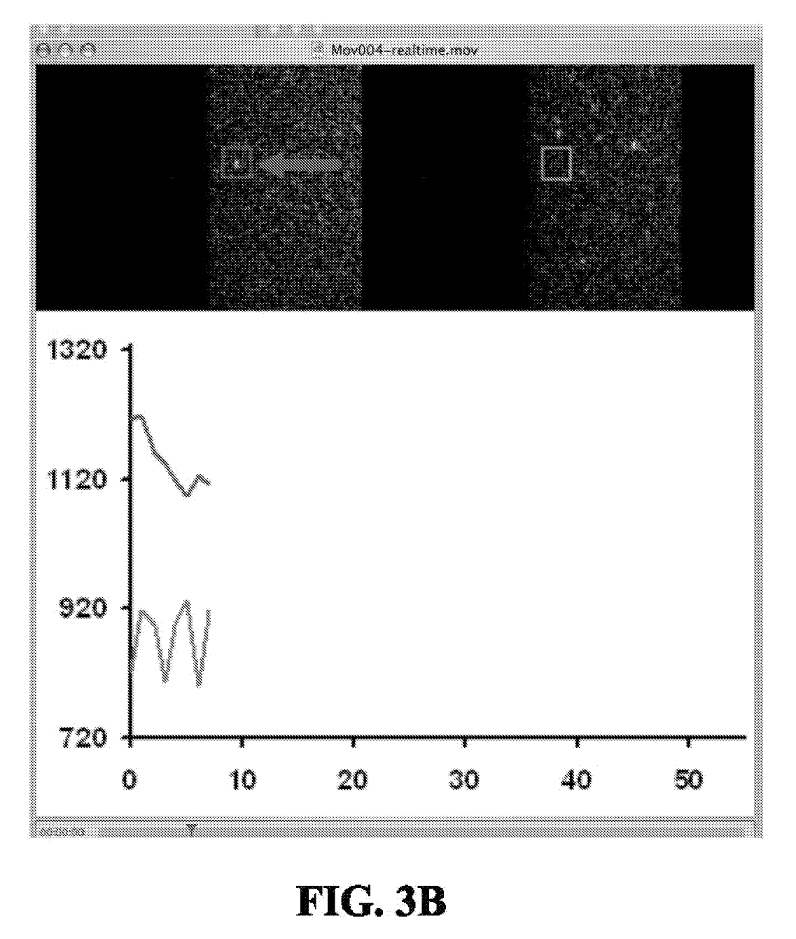

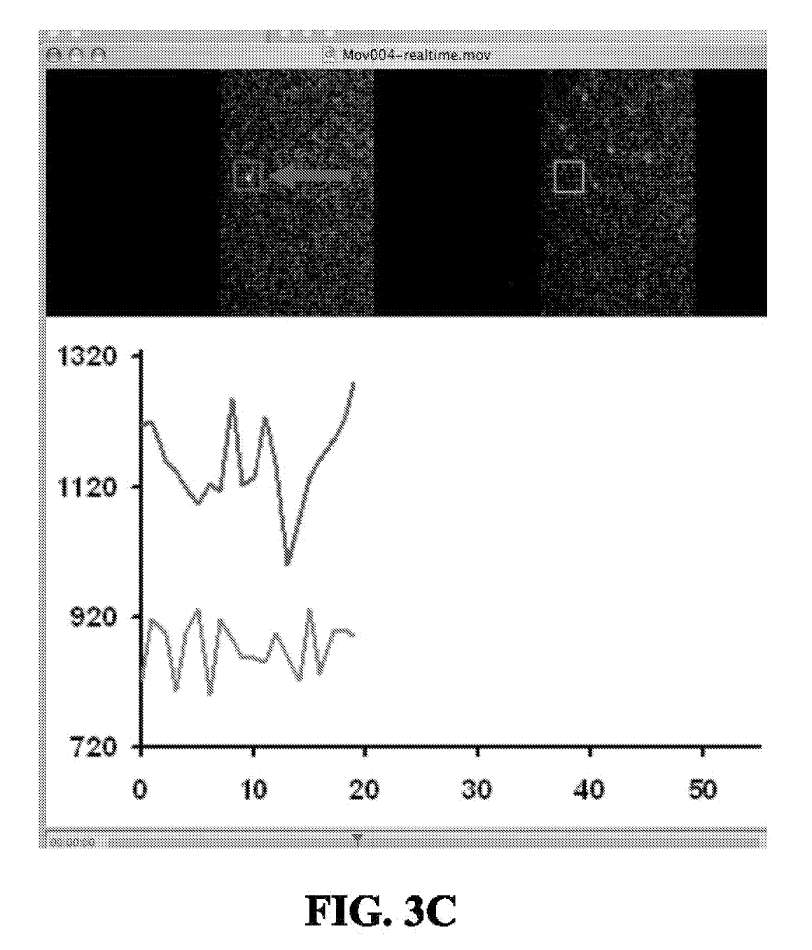

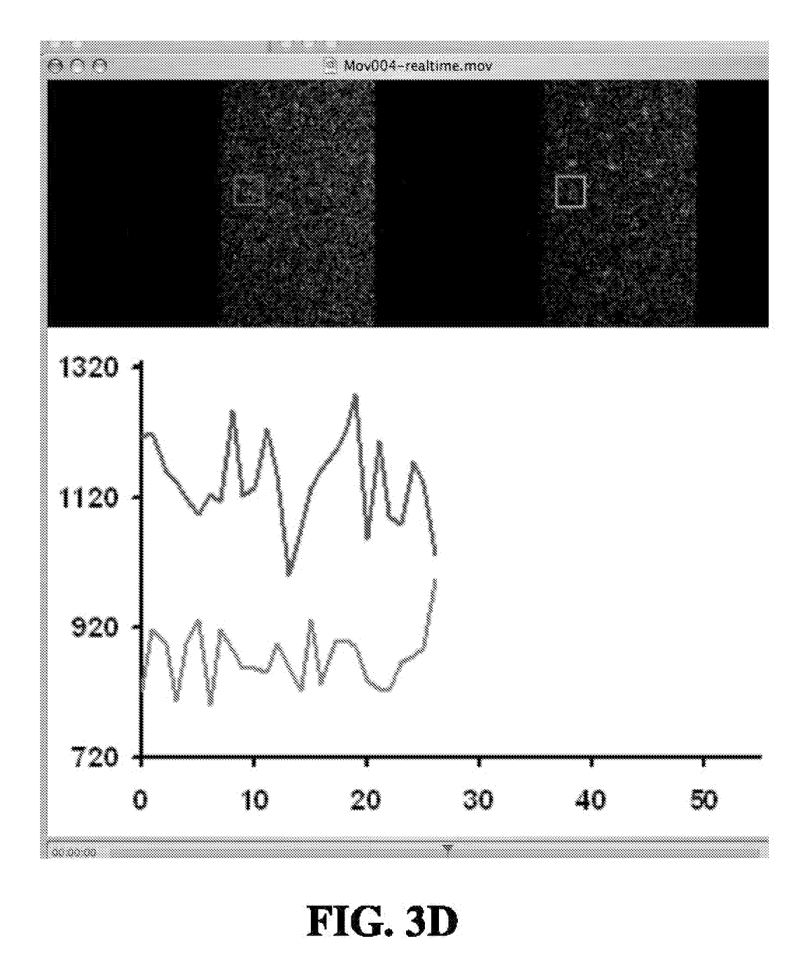

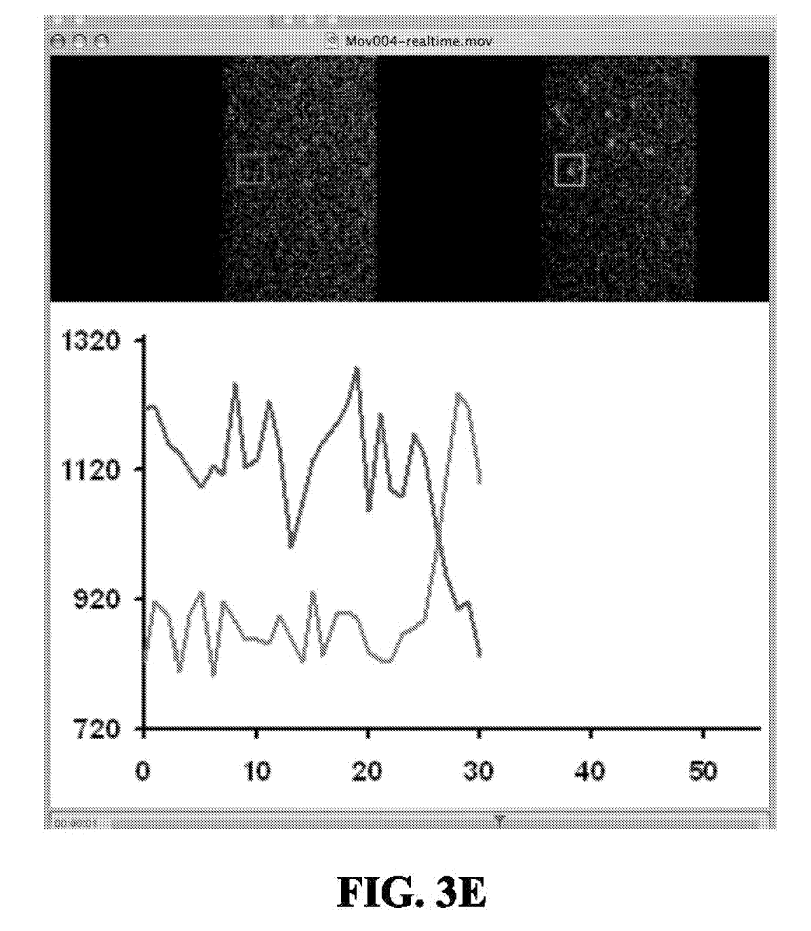

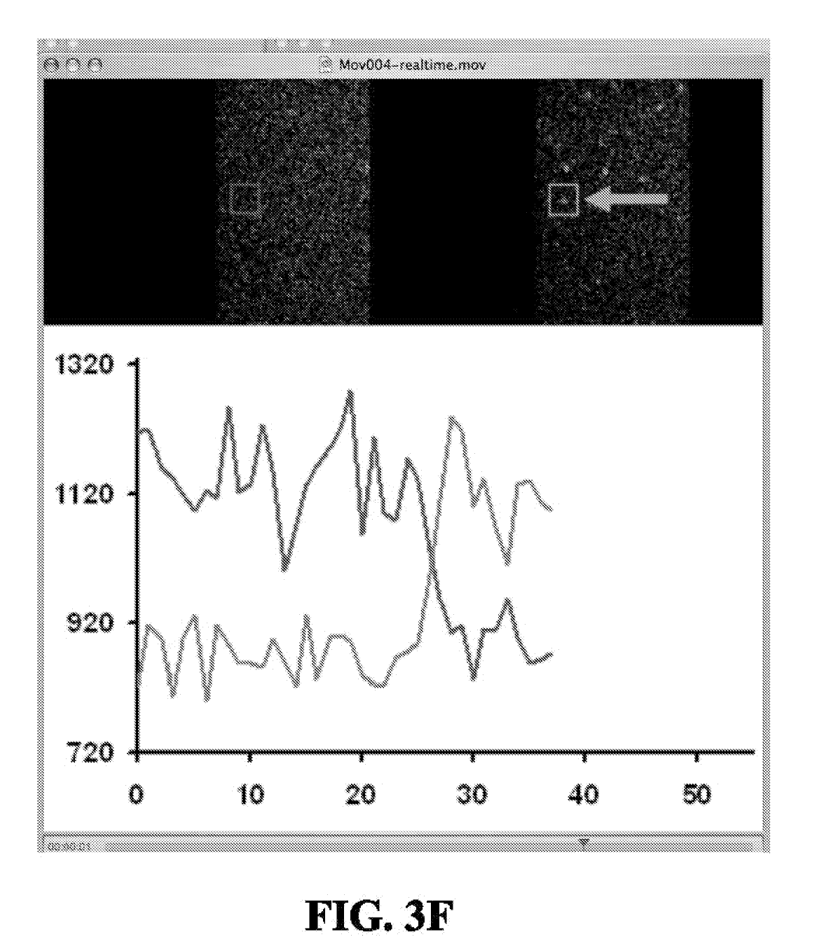

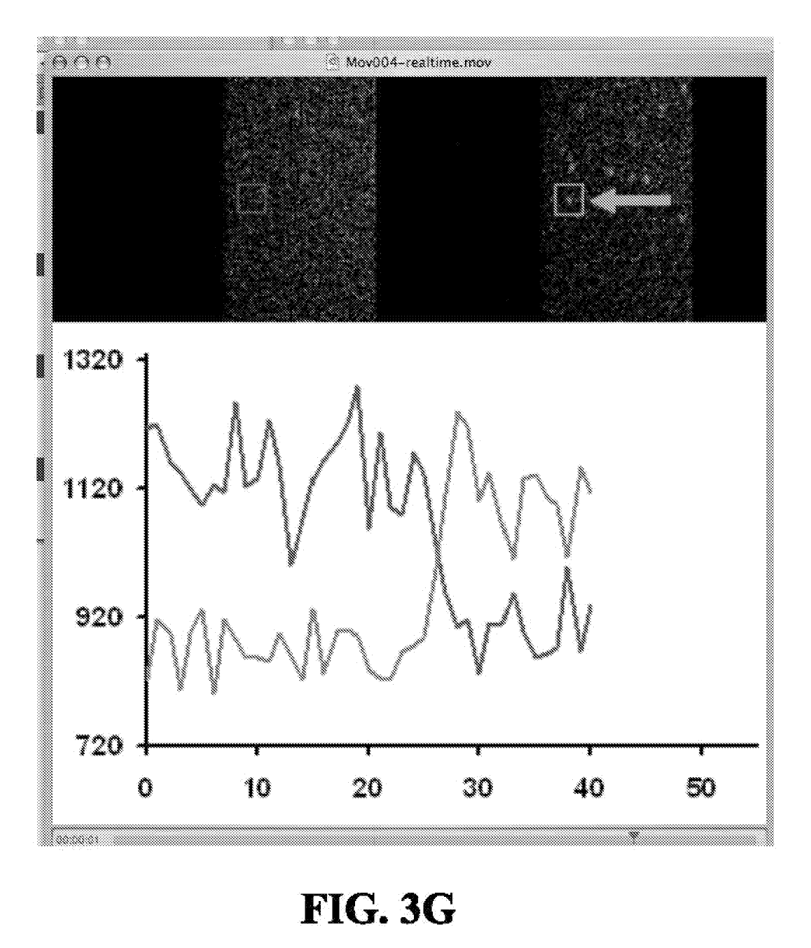

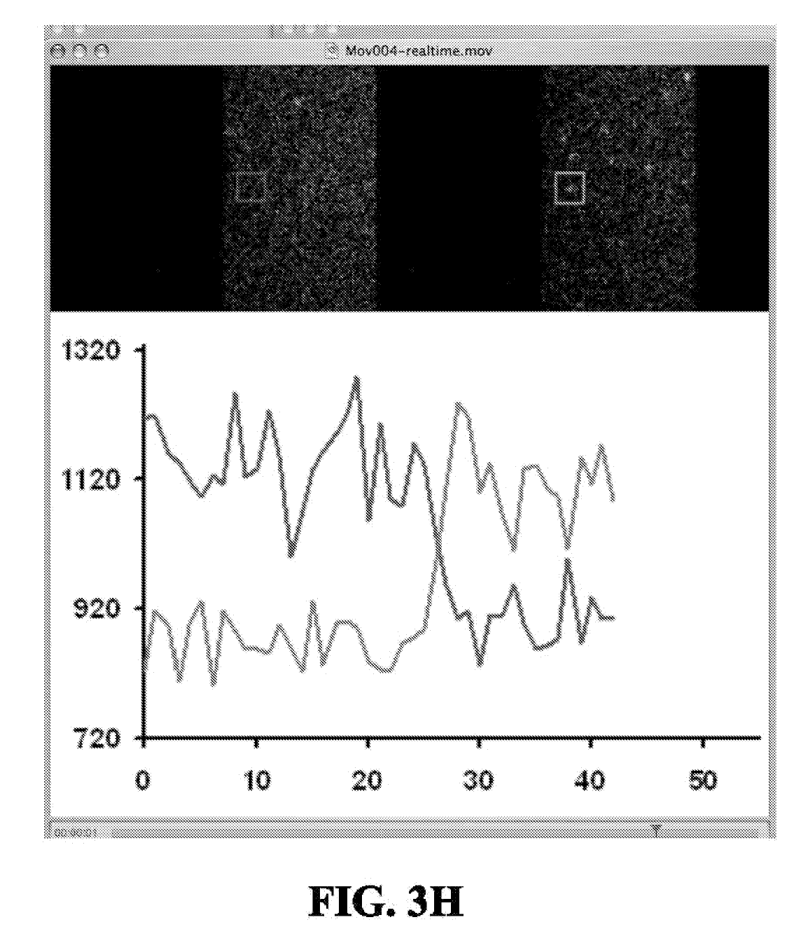

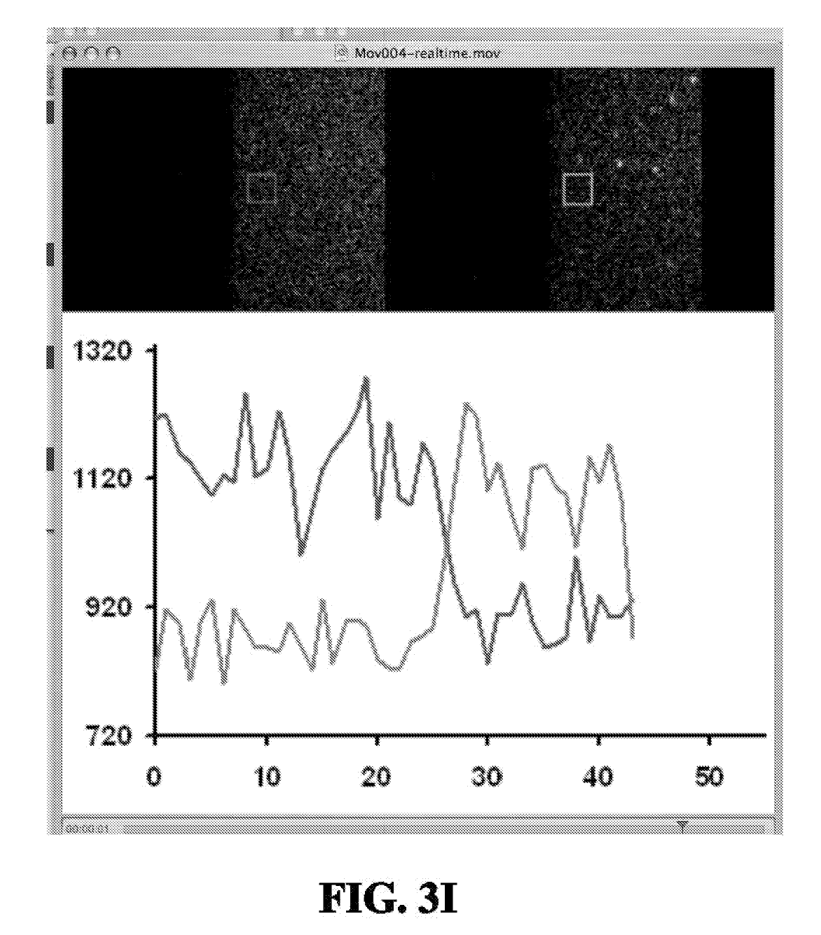

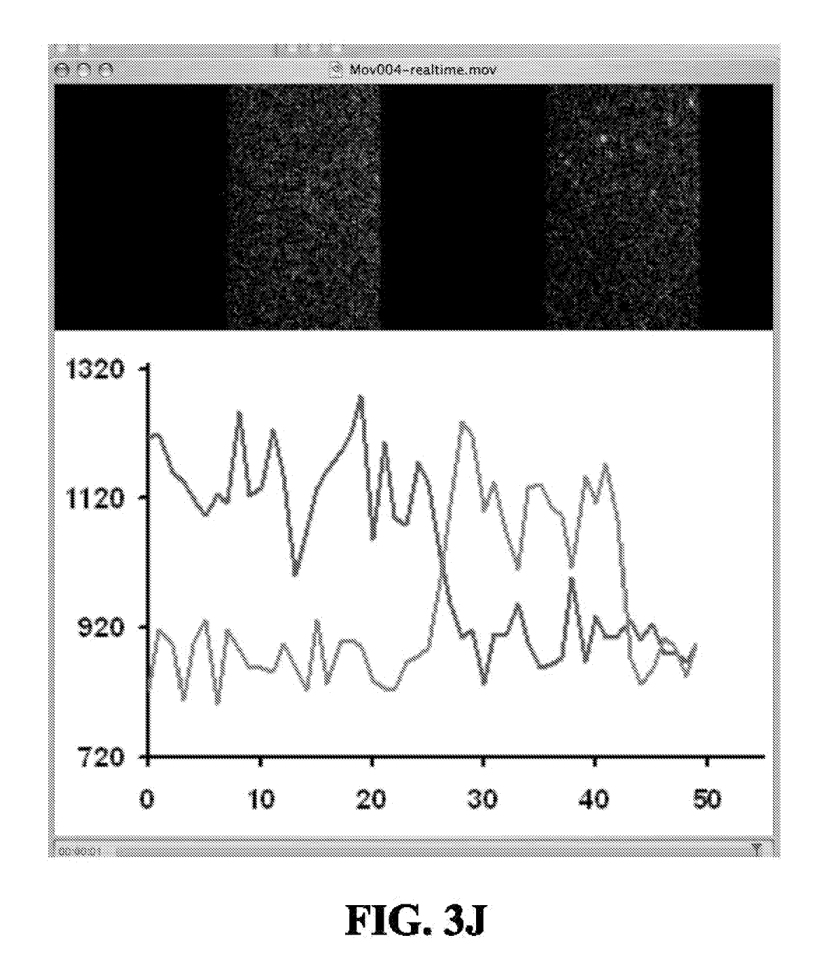

Referring now to FIGS. 3A-J, a series of camera frame images are shown the evidence detection while moving of another embodiment of a system of this invention. The images are coupled to plots showing the detected response of an acceptor channel and a donor channel, where the FRET interaction is evidence by the anti-correlated emission intensity from the two channels. Thus, as the donor intensity drops, the acceptor intensity rises evidencing a FRET event between the donor and acceptor. The moving frame images illustrate how the molecular sites propagate in the field of view (move along a controlled trajectory), which provides a mechanism of improved site recognition, signal detection, and signal analysis.

### Surface Preparation

A previously published method is used with minor modifications for the preparation of modified cover glass (Braslavsky et al., 2003).

Briefly, glass cover slips (0.16-0.19 mm thickness) are put 0/N in a base bath are then cleaned with 2% Micro-90 for 60 minutes with sonication and heat, followed by boiling RCA treatment for 60 minutes [2×30 mins]. The cleaned glass cover slips are then immersed in 2 mg/mL polyallylamine for 10 minutes and rinsed five times in water followed by an immersion in 2 mg/mL polyacrylic acid for 10 minutes and rinsed five times in water. This coating procedure is repeated again before the slides are coated with a 5 mM EDC-Biotin amine solution in 10 mM MES buffer, pH 5.5 for 30 minutes. After rinsing the slides in MES buffer for 5 minutes, in water for 5 minutes and in Trisb for 5 minutes, the final coat of 1 mg/mL Streptavidin is added by incubating for 30 minutes.

### Duplex Formation and Immobilization

The duplex to be immobilized is formed in solution prior to immobilization. The donor labeled template strand (Alexa Biotin Bot, 1 M) and acceptor labeled primer strand (Cy5 Top, 1 M) were mixed in 1× Klenow buffer, heated at 97° C. for 5 minutes, and allowed to cool to room temperature slowly over a period of one hour. The sample was diluted in 1× Klenow3 buffer to 25 pM, and immobilized on the PE surface at room temperature for 10 minutes. After immobilization, the excess sample was discarded and the cover glass was washed for 5 minutes in Trisb at room temperature, and mounted with 1× klenow buffer and observed under the microscope. The samples were excited using an argon laser and energy transfer between the donor and acceptor were detected via single pair FRET analysis. The distance between the donor and acceptor are ˜30 Å.

### Substrate Configurations

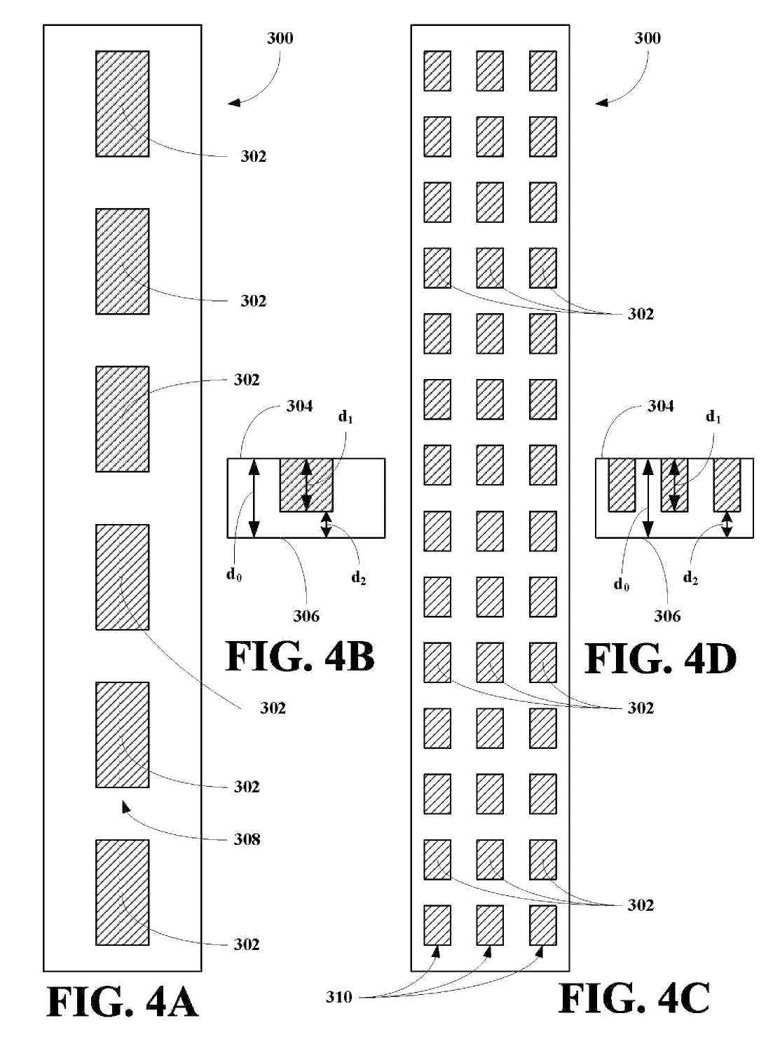

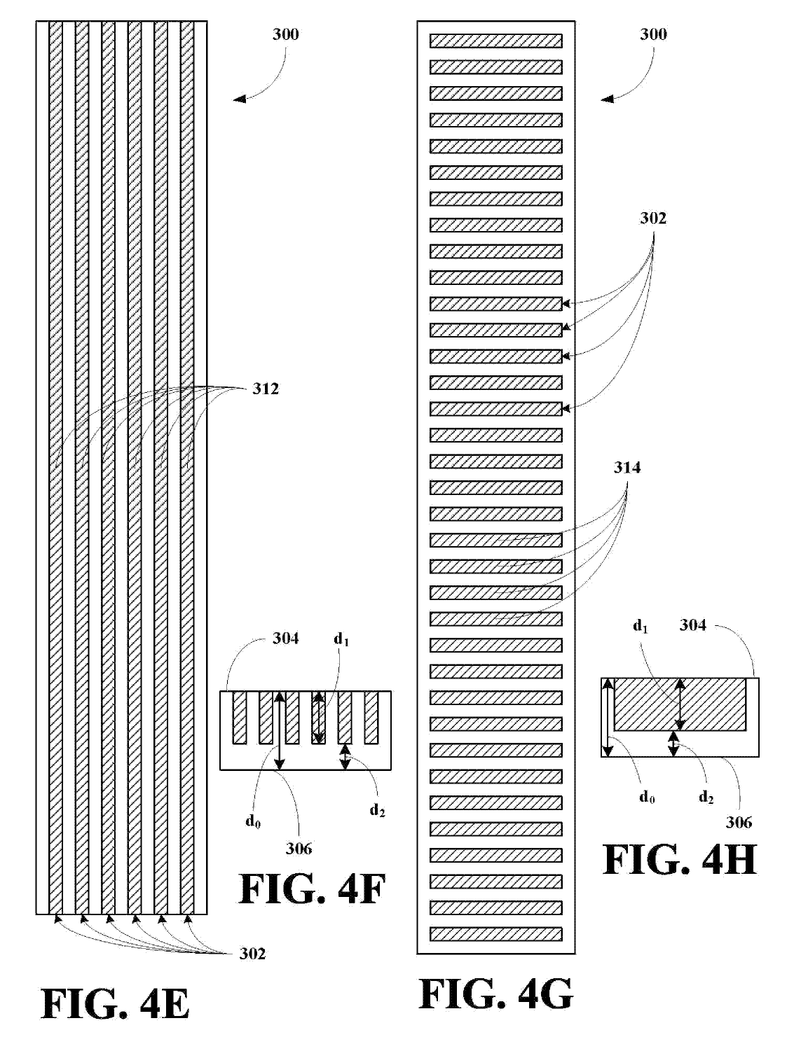

Referring now to FIGS. 4A-H, several embodiments of substrates useable in this invention, generally 300, are shown. Looking at FIGS. 4A-B, a substrate 300 having a thickness d₀ and including a plurality of spaced apart zones 302 disposed on a zone side 304 and having a depth d₁, while maintaining a sufficient remaining substrate thickness d₂ measured from a substrate back side 306. The zones 302 of this embodiment are disposed in a middle 308 of the substrate 300.

Looking at FIGS. 4C-D, a first substrate 300 having a thickness d₀ and including three parallel disposed rows 310, each row 310 includes a plurality of spaced apart zones 302 disposed on a zone side 304 and having a depth d₁, while maintaining a sufficient remaining substrate thickness d₂ measured from a substrate back side 306. The zones 302 of this embodiment are disposed in a middle 308 of the substrate 300. Although the zones are shown as rectangular, the shape is not meant as a limitation as the zones can be any shape including, without limitation, circular, elliptical, triangular, polygonal, or any other shape one would desire, being a design preference and not a limitation preference.

Looking at FIGS. 4E-F, a substrate 300 having a thickness d₀ and including a plurality zones 302 comprising parallel disposed, continuous bands 312, each band 312 is disposed on a zone side 304 and having a depth d₁, while maintaining a sufficient remaining substrate thickness d₂ measured from a substrate back side 306. The zones 302 of this embodiment are disposed in a middle 308 of the substrate 300. Of course, one of ordinary skill can recognize that the number of parallel bands 312 can be any number limited only by the width of the substrate and the size and spacing between the bands 312. Thus, the bands 312 could represent channels of a molecular dimension which can be prepared using modern chip photolithographic techniques.

Looking at FIGS. 4G-H, a substrate 300 having a thickness d₀ and including a plurality zones 302 comprising transversely disposed bands 314, each band 314 is disposed on a zone side 304 and having a depth d₁, while maintaining a sufficient remaining substrate thickness d₂ measured from a substrate back side 306. The zones 302 of this embodiment are disposed in a middle 308 of the substrate 300.

Looking at FIG. 4I, a substrate 300 having circular well shaped zones 302 is shown, in this configuration the zones include an immobilized primer with a 3′ photo-cleavage group for controlled reaction initiation, zones sized to correspond to the viewing field of the detector, and a marker for location interrogation, especially for chip based substrates.

Although several substrate configurations have been described above, it should be clear to ordinary artisans that other zone configurations can be inscribed in the surface of a substrate provided that the zones are capable of binding components within the zones and capable of being used in the apparatus.

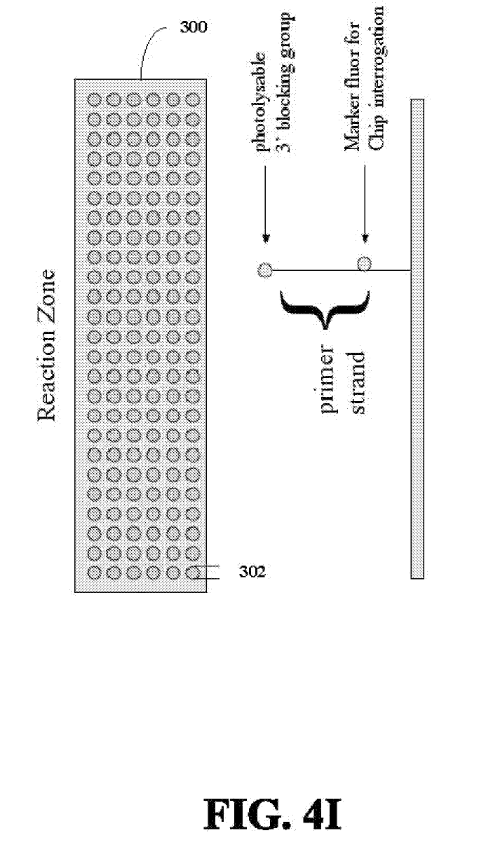

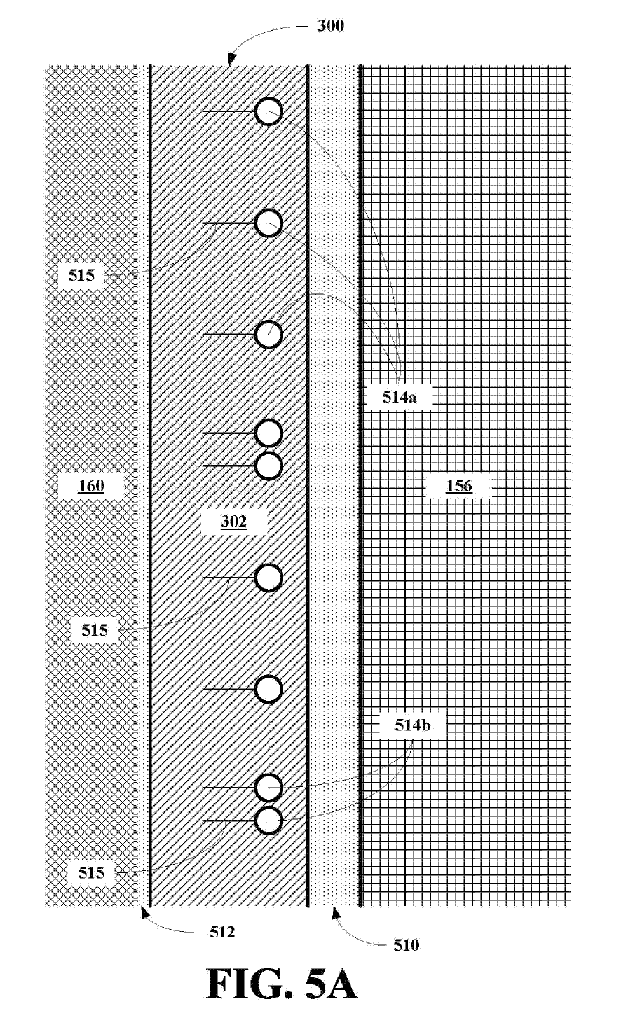

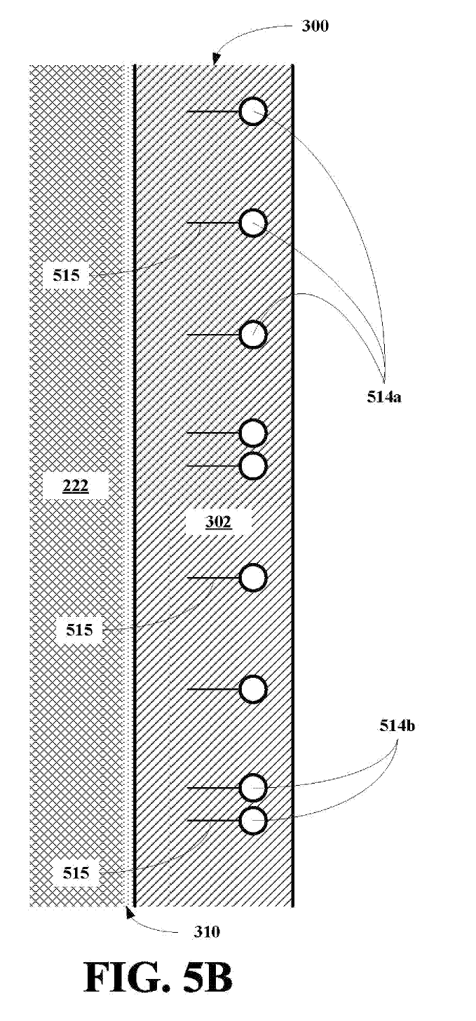

Referring now to FIG. 5A, an expanded view of the substrate in FIGS. 1A-C described above is shown. A zone 302 of the substrate 300 is shown sandwiched between the prism 108, 146, or 168 and the objective lens 132, 159, or 177. An oil film 510 is situated between the substrate 300 and the prism 108, 146, or 168 to reduce refraction of the incident light. The oil film 510 is an optical oil having the same refractive index as the substrate 300. An optional second oil film 512 may also be interposed between the objective 132, 159, or 177 and the substrate to reduce light refraction. The light beam (not shown) is entering from the right through the prism 108, 146, or 168 at the critical angle for total internal reflection. The zone 302 includes bound molecular assemblages 514. The assemblages 514a represent assemblages that would give rise to individually discernible detection events, while the assemblages 514b represent sites that would not lead to individually discernible detection events because two or more assemblages are located too close to each other. The tails 515 extending from the assemblages 514 represent growing product resulting from the incorporation reactions occurring within the zone. These sites with multiple donor emissions would be rejected as suitable sites during the mapping process.

Referring now to FIG. 5B, an expanded view of the substrate in FIGS. 2A-C described above is shown. A zone 302 of the substrate 300 is shown situated below the objective lens 222, 253, or 280. An oil film 510 is situated between the substrate 300 and the objective lens 222, 253, or 280 to reduce refraction of the incident light. The oil film 510 is an optical oil having the same refractive index as the substrate 300. The zone 302 includes bound molecular assemblages 514. The assemblages 514a represent assemblages that would give rise to individually discernible detection events, while the assemblages 514b represent sites that would not lead to individually discernible detection events because two or more assemblages are located too close to each other. The tails 515 extending from the assemblages 514 represent growing product resulting from the incorporation reactions occurring within the zone. These sites with multiple donor emissions would be rejected as suitable sites during the mapping process.

All references cited herein are incorporated by reference. Although the invention has been disclosed with reference to its embodiments, from reading this description those of skill in the art may appreciate changes and modification that may be made which do not depart from the scope and spirit of the invention as described above and claimed hereafter.

1.-19. (canceled)

20. A method for analyzing one or an ensemble of active sites comprising the steps of:
providing a substrate including a zone, where the zone includes one or a plurality of sparsely distributed sites, each site including one or more atomic systems, molecules, molecular complexes or molecular assemblages and at least one detectable agent having a detectable property,
detecting, with a detection system, reactions and/or interactions occurring at least one of the one or plurality of sites within a viewing field of a detector of the detection system to produce detected event signals,
moving the viewing field in a controlled manner during the detecting, where the motion is adapted to improve location of active sites, improve signal recognition, improve noise identification and reduction, and/or improve signal-to-noise ratio of detected, and
analyzing the detected event signals to convert the signals into data about the detected events.

21. The method of claim 20, wherein the method is performed in a continuous reaction mode, an intermittent reaction mode, a periodic reaction mode, semi-periodic reaction mode, or mixed mode (a mixture of one or more of the other modes in any combination or permutation).

22. The method of claim 20, wherein the sites are confined on or in the zone or immobilized to binding agents sparsely distributed on or in the zone.

23. The method of claim 20, wherein the providing step comprises:
first forming one or a plurality of pre-active sites on or on the zone,
mapping the pre-active sites within the viewing field prior, and
activating the pre-active sites to form the active sites.

24. The method claim 20, wherein moving step comprises moving the substrate via a substrate motor in the controlled manner, moving the light source via a light source motor in the controlled manner or moving the detector via a detector motor in a controlled manner.

25. The method of claim 20, wherein the motion comprises controlled trajectory.

26. The method of claim 25, wherein the controlled trajectory includes control of direction, speed, linear acceleration, angular acceleration, and/or a combination of these components of motion.

27. The method of claim 25, wherein the controlled trajectory is selected from the group consisting of a linear trajectory, circular trajectory, elliptical trajectory, hyperbolic trajectory, rectangular trajectory, triangular trajectory, back-and-forth trajectory, side-to-side trajectory, or any other trajectory that permits the detectable molecules, complexes or assemblages to move within the viewing field.

28. The method of claim 20, wherein the reactions and/or interactions are evidenced by a change in at least one of the detectable properties of one or more of the detectable agents before, during and/or after one or each of a series of the reactions and/or interactions.

29. A method for analyzing one or an ensemble of active sites comprising the steps of:
providing a substrate including a zone, where the zone includes one or a plurality of sparsely distributed donor structure sites, each donor structure site including a donor capable of transferring energy to an acceptor,
converting the acceptor into a detectable agent, where each donor structure site includes a binding agent adapted to immobilize a molecule, at least one component of an atomic system, at least one component of a molecular complex or at least one component of a molecular assemblage molecule,
introducing a molecule, at least one component of an atomic system, at least one component of a molecular complex or at least one component of a molecular assemblage molecule to the substrate to convert some or all of the donor sites into immobilized molecular, atomic, molecular complex and molecular assemblage sites;
detecting, with a detection system, reactions and/or interactions occurring at the sites within a viewing field of a detector of the detection system to produce detected event signals, and
analyzing the detected event signals to convert the signals into data about the detected events.
